(19) United States
(12) Patent Application Publication
(10) Pub. No.: US 2026/0316471 A1
(43) Pub. Date: Oct. 15, 2026

(54) PRINTING CONSUMABLE AND PRINTER EQUIPPED THEREWITH

(71) Applicant: ZHUHAI QUIN TECHNOLOGY CO., LTD., Zhuhai (CN)

(72) Inventors: Yiyin WU, Zhuhai (CN); Gang WU, Zhuhai (CN); Jinpeng GUO, Zhuhai (CN)

(73) Assignee: ZHUHAI QUIN TECHNOLOGY CO., LTD., Zhuhai (CN)

(21) Appl. No.: 19/647,777

(22) Filed: Apr. 14, 2026

(30) Foreign Application Priority Data
Apr. 15, 2025 (CN) 202520716428.X
Mar. 30, 2026 (CN) 202620409925.X

(51) Int. Cl. B41J 33/20; B41J 2/325; B41J 32/00; B41J 33/00; B41J 35/00

(52) U.S. Cl. CPC B41J 33/20; B41J 2/325; B41J 32/00; B41J 33/003; B41J 35/00

(57) ABSTRACT

A printing consumable includes a housing, a first spool core and a receiving portion. The housing has a first outlet. The first spool core is rotatably disposed in the housing. The receiving portion is disposed on the housing, the receiving portion has a receiving surface exposed from the housing, and the receiving surface is configured to cooperate with a first ribbon driving wheel to provide a clamping force. According to the printing consumable, the receiving portion is used for improving a structural strength of the housing, so that a connection structure between the receiving portion and the housing is simplified, and thus improving an assembly efficiency.

### CROSS-REFERENCE TO RELATED APPLICATIONS

This application claims priority to Chinese Patent Application No. 202520716428.X, filed on Apr. 15, 2025, and Chinese Patent Application No. 202620409925.X, filed on Mar. 30, 2026. The disclosures of the aforementioned applications are hereby incorporated by reference their entireties.

### TECHNICAL FIELD

The present disclosure relates to the field of printing technologies, and in particular, to a printing consumable and a printer having the printing consumable.

### BACKGROUND

With the development of thermal transfer printing technologies, a printer adopting thermal transfer printing technology has become indispensable equipment in daily office work and study. To realize a printing function of a printer, a printing consumable is an essential component of the printer.

In related technologies, a structure of the printing consumable is complex, a structural strength of a housing of the printing consumable is low, and an assembly efficiency of the printing consumable is low. Therefore, there is an urgent requirement for an improved printing consumable.

### SUMMARY

The present disclosure provides a printing consumable and a printer having the printing consumable, which is capable of improving a structural strength of a housing of the printing consumable, so that a connection structure between a receiving portion and the housing is simplified, and thus improving an assembly efficiency.

In a first aspect, the present disclosure provides a printing consumable for a printer. The printer includes a printer main body, and the printer main body has a first ribbon driving wheel. The printing consumable includes a housing, a first spool core and a receiving portion. The housing has a first outlet. The first spool core being is rotatably disposed in the housing. The receiving portion is disposed in the housing, the receiving portion has a receiving surface exposed from the housing, and the receiving surface is configured to cooperate with the first ribbon driving wheel to provide a clamping force.

According to the printing consumable of the embodiment of the present disclosure, a receiving portion having a receiving surface is provided on the housing of the printing consumable. The receiving surface of the receiving portion cooperates with the first ribbon driving wheel to provide a clamping force. In this way, on one hand, the receiving portion is used for improving a structural strength of the housing, simplifying a connection structure between the receiving portion and the housing, and improving an assembly efficiency of the printing consumable; and on the other hand, it is not necessary to reserve a clearance space inside the housing of the printing consumable, which is beneficial for reducing a size of the printing consumable, and thus facilitating a miniaturization design of the printer.

In a possible implementation of the first aspect of the present disclosure, the housing also has a second outlet, and the second outlet is spaced apart from the first outlet. The printing consumable includes a second spool core, and the second spool core is rotatably disposed in the housing.

In a possible implementation of the first aspect of the present disclosure, a peripheral side wall of the housing has an opening, the opening has a first wall surface and a second wall surface facing each other, the receiving portion is located at the opening and is disposed closer to the first wall surface relative to the second wall surface, the receiving surface is exposed via the opening, and the second outlet is defined between the receiving portion and the second wall surface.

In a possible implementation of the first aspect of the present disclosure, a surface of the receiving portion close to the second wall surface is a guide convex curved surface, and the guide convex curved surface is connected to the receiving surface.

In a possible implementation of the first aspect of the present disclosure, the guide convex curved surface is an arc-shaped surface; and/or, the guide convex curved surface is tangent to the receiving surface.

In a possible implementation of the first aspect of the present disclosure, an outer peripheral surface of the receiving portion is provided with a first positioning structure, an inner surface of the housing is provided with a second positioning structure, the first positioning structure is one of a protrusion and a groove, the second positioning structure is the other of the protrusion and the groove, and the protrusion fits within the groove.

In a possible implementation of the first aspect of the present disclosure, the first positioning structure is provided on a side of the receiving portion facing away from the guide convex curved surface.

In a possible implementation of the first aspect of the present disclosure, a wall plate on a side of the housing along a first direction is a first wall plate, the first wall plate has a first clearance hole, the receiving portion has a second clearance hole penetrating through the receiving portion along the first direction, the second clearance hole and the first clearance hole are directly opposite to each other in the first direction, and the first clearance hole and the second clearance hole are configured to avoid a ribbon driving shaft of the printer main body.

In a possible implementation of the first aspect of the present disclosure, the receiving portion includes a first sleeve, a second sleeve and a connecting rib, an outer peripheral surface of the first sleeve has the receiving surface, the second sleeve is located inside the first sleeve and is spaced apart from the first sleeve, the second sleeve forms at least a portion of the second clearance hole, and the connecting rib is connected between the first sleeve and the second sleeve.

In a possible implementation of the first aspect of the present disclosure, a wall plate on the other side of the housing along the first direction is a second wall plate, the first sleeve is clamped between the first wall plate and the second wall plate, an end face of the first sleeve facing the first wall plate is provided with a limiting plate, and the limiting plate is located in the first clearance hole and cooperates with a hole wall of the first clearance hole for limiting.

In a possible implementation of the first aspect of the present disclosure, the second wall plate has a limiting hole, and an end of the second sleeve away from the first clearance hole is limited within the limiting hole.

In a possible implementation of the first aspect of the present disclosure, an inner surface of the housing is provided with a protruding portion, the protruding portion is located on a side of the receiving portion facing away from the receiving surface and cooperates with the receiving portion to limit deformation of the receiving portion toward a side where the protruding portion is located.

In a possible implementation of the first aspect of the present disclosure, an outer surface of the housing is recessed inward to form a protruding portion on the inner surface of the housing and form a recessed portion on the outer surface of the housing that is similar in shape to the protruding portion.

In a second aspect, the present disclosure provides a printer. The printer includes the printer main body and the printing consumable. The printing consumable is detachably mounted on the printer main body, and the first ribbon driving wheel is configured to convey a finished ribbon outward.

Technical effects of the second aspect of the present disclosure may be referred to the technical effects of the first aspect, which will not be repeated herein.

In a possible implementation of the second aspect of the present disclosure, a friction coefficient of the receiving surface is less than a friction coefficient of an outer peripheral surface of the first ribbon driving wheel.

In a third aspect, the present disclosure provides a printing consumable. The printing consumable includes a housing and a ribbon accommodated in the housing. The housing includes a first wall plate, a second wall plate and a side plate connecting the first wall plate and the second wall plate. The side plate is provided with a mating area and a first opening that are capable of exposing a partial section of the ribbon, and a spool rotatably is disposed in the housing for winding the ribbon, to make the ribbon be driven to move to the mating area. Along a supply path of the ribbon, the first opening is located on an upstream side of the mating area, the first opening is provided with a first limiting member, the first limiting member covers a portion of the first opening and is located on an outer side of the ribbon in a first direction, and the first direction is perpendicular to a ribbon surface of the ribbon.

In a fourth aspect, the present disclosure also provides a printing consumable. The printing consumable includes a housing and a ribbon accommodated in the housing. The housing includes a first wall plate, a second wall plate and a side plate connecting the first wall plate and the second wall plate. A side plate of the housing is provided with a mating area and a first opening that are capable of exposing a portion of the ribbon, and a spool rotatably is disposed the housing for winding the ribbon, to make the ribbon be driven to move to the mating area. The first opening is located on a side of the mating area facing an upstream side of a supply path of the ribbon, and the first opening is provided with a flattening member, the flattening member covers a portion of the first opening and is located on an outer side of the ribbon in a first direction, to contact with a surface of the ribbon at least in some situations.

In a possible implementation of the second aspect of the present disclosure, the flattening member includes a rolling member rotatably arranged, and an axial direction of the rolling member is perpendicular to the first direction.

In a fifth aspect, the present disclosure also provides a printer. The printer includes a printer main body and the printing consumable according to any one of the above embodiments. The printing consumable is detachably mounted on the printer main body, and is driven by a driving member on the printer main body to discharge the ribbon along a predetermined supply path.

### BRIEF DESCRIPTION OF THE DRAWINGS

FIG. 1A is a perspective view of a printing consumable provided by an embodiment of the present disclosure.

FIG. 1B is a perspective view of a printing consumable provided by an embodiment of the present disclosure, where an adhesive ribbon, a printing ribbon, and a finished ribbon are not shown.

FIG. 1C is a perspective view of a printing consumable provided by an embodiment of the present disclosure, where an adhesive ribbon, a printing ribbon, and a finished ribbon are not shown.

FIG. 2 is an exploded view of the printing consumable shown in FIG. 1A.

FIG. 3 is a front view of the printing consumable shown in FIG. 1A along a first direction, where a printing head in FIG. 3 does not belong to the printing consumable and is therefore drawn with a dashed line.

FIG. 4 is a rear view of the printing consumable shown in FIG. 1A along a first direction.

FIG. 5 is a front view of a partial structure of the printing consumable shown in FIG. 1A along a first direction.

FIG. 6 is a perspective view of a receiving portion shown in FIG. 2.

FIG. 7 is a cross-sectional view of the printing consumable shown in FIG. 3 taken along a line A-A.

FIG. 8 is an enlarged view of a portion circled at B in a structure shown in FIG. 7.

FIG. 9 is a perspective view of a first housing shown in FIG. 2.

FIG. 10 is an enlarged view of a portion circled at C in the first housing shown in FIG. 9.

FIG. 11 is an enlarged view of a portion circled at D in the printing consumable shown in FIG. 1A.

FIG. 12 is a schematic structural diagram of a housing in an embodiment of the present disclosure.

FIG. 13 is a schematic diagram of cooperation between a printing consumable and components on a printer main body in an embodiment of the present disclosure.

FIG. 14 is a schematic structural diagram of a first housing portion in an embodiment of the present disclosure.

FIG. 15 is a schematic structural diagram of a second housing portion in an embodiment of the present disclosure.

FIG. 16 is a first schematic structural diagram of a printing consumable in an embodiment of the present disclosure.

FIG. 17 is a second schematic structural diagram of a printing consumable in an embodiment of the present disclosure.

FIG. 18 is a third schematic structural diagram of a printing consumable in an embodiment of the present disclosure.

FIG. 19 is a fourth schematic structural diagram of a printing consumable in an embodiment of the present disclosure.

FIG. 20 is a fifth schematic structural diagram of a printing consumable in an embodiment of the present disclosure.

FIG. 21 is a sixth schematic structural diagram of a printing consumable in an embodiment of the present disclosure.

FIG. 22 is a schematic structural diagram of a reinforcement rib in a guide hole in an embodiment of the present disclosure.

FIG. 23 is a seventh schematic structural diagram of a printing consumable in an embodiment of the present disclosure.

FIG. 24 is an eighth schematic structural diagram of a printing consumable in an embodiment of the present disclosure.

### DETAILED DESCRIPTION OF THE EMBODIMENTS

Technical solutions in embodiments of the present disclosure will be clearly and completely described below with reference to the accompanying drawings in the embodiments of the present disclosure. Obviously, the described embodiments are only a portion of the embodiments of the present disclosure, rather than all of them. Based on the embodiments of the present disclosure, all other embodiments obtained by those with ordinary skill in the art without creative efforts shall fall within the protection scope of the present disclosure.

In the present disclosure, the accompanying drawings are not necessarily drawn to scale, and local features may be enlarged or reduced to more clearly show the details of the local features.

Unless otherwise specified, all technical and scientific terms used in the present disclosure have the same meanings as those commonly understood by those skilled in the technical field of the present disclosure. The terms used in the present disclosure are only for the purpose of describing specific embodiments, and are not intended to limit the scope of the present disclosure. The term "and/or" used in the present disclosure includes any and all combinations of one or more related listed items. The singular forms "a", "the", and "said" used in the present disclosure and the appended claims are also intended to include plural forms, unless the context clearly indicates otherwise.

In the description of the present disclosure, it should be understood that the terms "first" and "second" are used for descriptive purposes only, and cannot be understood as indicating or implying relative importance or implicitly indicating the number of indicated technical features. Therefore, features defined with "first" and "second" may explicitly or implicitly include one or more of these features. In the description of the present disclosure, "a plurality of" means two or more, unless otherwise specifically and clearly defined. In the description of the present disclosure, "several" means one or more, unless otherwise specifically and clearly defined.

In the description of the present disclosure, terms such as "length", "width", "thickness", "inner", "outer", or the like, indicating orientation or positional relationships are based on the orientation or positional relationships shown in the accompanying drawings. They are only for the convenience of simplifying the description of the present disclosure, and do not indicate or imply that the referred device or element must have a specific orientation, or be constructed and operate in a specific orientation, that is, they cannot be understood as limitations on the present disclosure.

In the description of the present disclosure, unless otherwise explicitly defined, terms such as "mounting", "connected", "connection", "fixed", "setting", or the like, should be understood broadly. For example, "connection" may be a fixed connection, a detachable connection, or an integral connection; it may be a mechanical connection or an electrical connection; it may be a direct connection, an indirect connection through an intermediate medium, or an internal connection between two elements or an interaction relationship between two elements. For those with ordinary skill in the art, the specific meanings of the above terms in the present disclosure may be understood according to specific circumstances.

In the description of the present disclosure, unless otherwise explicitly defined, a first feature being "on", "above", "over", "under", "below", or "beneath" a second feature may mean that the first feature and the second feature are in direct contact, or that the first feature and the second feature are in indirect contact through an intermediate medium. Moreover, the first feature being "above", "over", or "on" the second feature may mean that the first feature is directly above or obliquely above the second feature, or merely indicates that a horizontal height of the first feature is higher than a horizontal height of the second feature. The first feature being "under", "below", or "beneath" the second feature may mean that the first feature is directly below or obliquely below the second feature, or merely indicates that the horizontal height of the first feature is lower than the horizontal height of the second feature.

In related technologies, a printer includes a printer main body and a printing consumable.

Among them, the printer main body includes a housing, a first ribbon driving wheel, an impression wheel, a printing head, a driving motor and a gear assembly. The first ribbon driving wheel, the impression wheel, the printing head, the driving motor, and the gear assembly are all mounted in the housing. An ink ribbon recovery shaft and a ribbon driving shaft are also rotatably mounted in the housing. The gear assembly includes a first gear, a second gear and a third gear. The first gear is fixed on the ink ribbon recovery shaft. The second gear is fixed on the ribbon driving shaft. The third gear is disposed on the first ribbon driving wheel. The driving motor is configured to drive the first gear, the second gear and the third gear to rotate.

The printing consumable includes a first spool core wound with a printing ribbon, a second spool core wound with an adhesive ribbon, a third spool core wound with an ink ribbon, a second ribbon driving wheel and an ink ribbon recovery wheel. Among them, the second ribbon driving wheel is connected to the ribbon driving shaft, and the ink ribbon recovery wheel cooperates with the ink ribbon recovery shaft. When the driving motor is operating, the gear assembly is rotated, which drives the second ribbon driving wheel, the ink ribbon recovery wheel and the first ribbon driving wheel to rotate synchronously.

When the printer is operating, driven by the driving motor, an unused printing ribbon and an ink ribbon are pulled between the printing head and the impression wheel, and are clamped by the printing head and the impression wheel to undergo thermal transfer printing. Then, the used ink ribbon is wound onto the ink ribbon recovery wheel. Next, the printing ribbon carrying printing information and the adhesive ribbon are clamped and bonded at the first ribbon driving wheel and the second ribbon driving wheel, and then are discharged from an outlet of the printer.

The above-mentioned printing consumable has the following disadvantages.

First, since the second ribbon driving wheel is rotatable relative to the housing of the printing consumable, the housing is required to be provided with a structure for rotatably cooperating with the second ribbon driving wheel. The setting of the second ribbon driving wheel makes a structure of the printing consumable be complicated, which affects an assembly efficiency of the printing consumable, and is not conducive to improving a structural strength of the housing of the printing consumable.

Second, because the second ribbon driving wheel is rotated, a relatively large movement space is required to be reserved for the second ribbon driving wheel in the printing consumable, so that a size of the printing consumable is relatively large, and thus is not conducive to a miniaturization design of the printer.

Third, the second ribbon driving wheel of the printing consumable can only adapt to printers with a ribbon driving shaft, resulting in poor adaptability.

Based on this, to solve the above technical problems, the present disclosure provides a printing consumable. In this printing consumable, the second ribbon driving wheel is no longer provided. Instead, a receiving portion with a receiving surface is provided on the housing of the printing consumable. Moreover, the receiving surface of the receiving portion and the first ribbon driving wheel provide a clamping force for the printing ribbon carrying printing information and the adhesive ribbon, so that the two are bonded, and the rotation of the first ribbon driving wheel is used to convey the finished ribbon to the outside of the printer. In this way, on one hand, the receiving portion is used to improve the structural strength of the housing and simplify a connection structure between the receiving portion and the housing, and thus improving the assembly efficiency; on the other hand, there is no requirement to reserve a movement space in the housing of the printing consumable, which is conducive to reducing the size of the printing consumable and realizing the miniaturization design of the printer. Moreover, the printer main body does not require to add a second gear and a ribbon driving shaft, reducing a loss of the driving motor's output power during transmission, and thus lowering the energy consumption and cost of the printer.

The embodiments of the present disclosure will be described in detail below with reference to the accompanying drawings.

The present disclosure provides a printer. The printer includes but is not limited to a thermal printer or a thermal transfer printer.

According to an embodiment of the present disclosure, the printer may include a printer main body and a printing consumable.

The printing consumable is detachably mounted on the printer main body. In this way, the printing consumable can be easily attached and detached.

For example, a detachable connection method between the printing consumable and the printer main body includes but is not limited to a snap-fitting manner.

A specific structure of the printer main body is well known to those skilled in the art, and will not be repeated herein.

The following will focus on the detailed description of the structure of the printing consumable of the present disclosure.

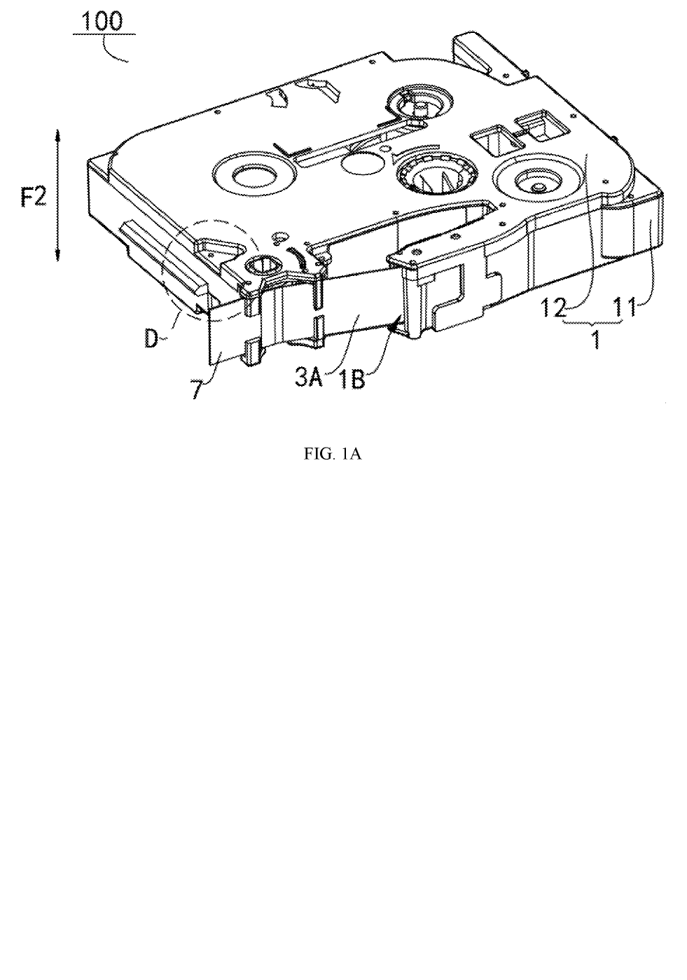

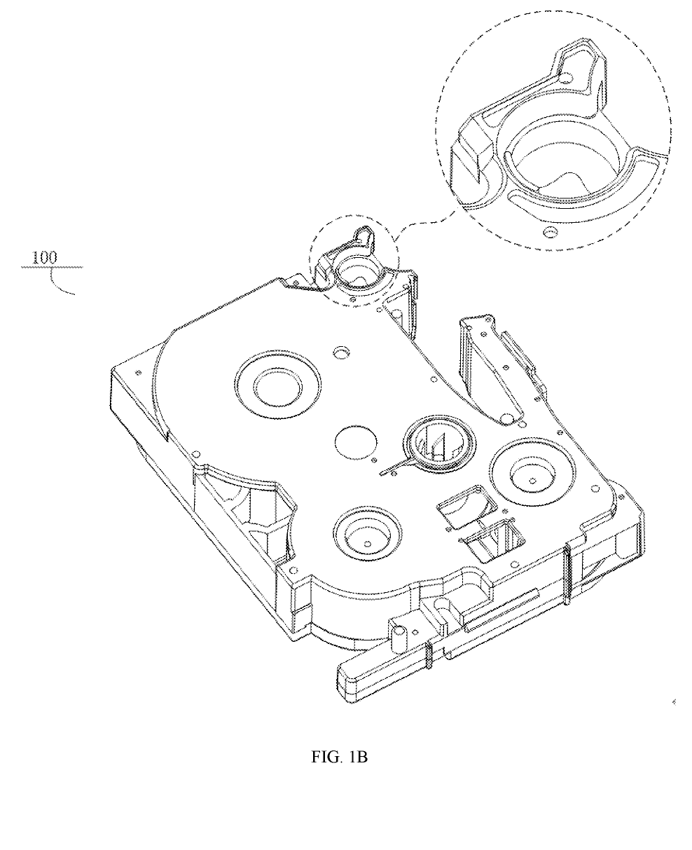

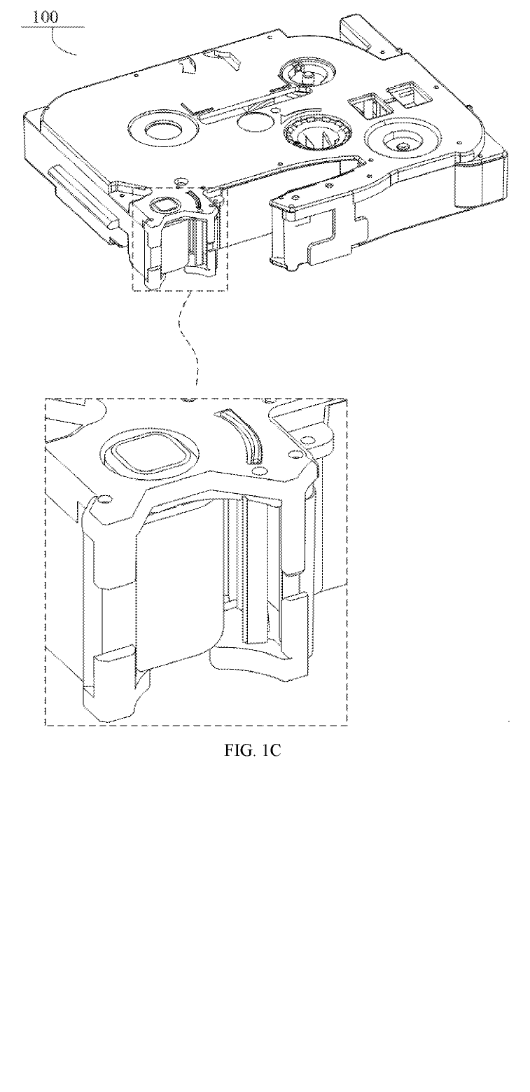

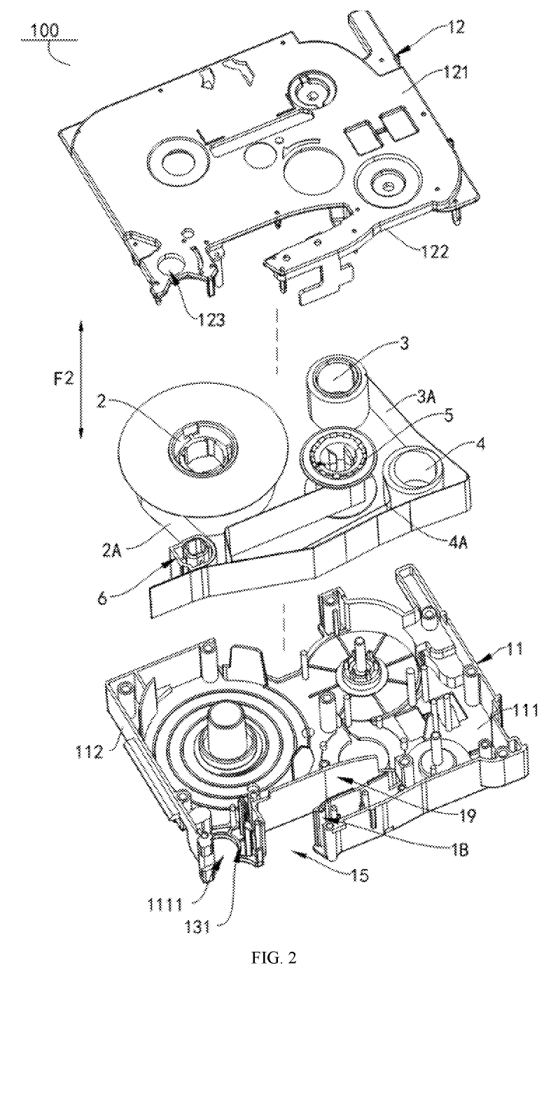

Please refer to FIGS. 1A, 1B, 1C, and 2. FIG. 1A is a perspective view of a printing consumable 100 provided by an embodiment of the present disclosure. FIG. 1B is a perspective view of a printing consumable 100 provided by an embodiment of the present disclosure. FIG. 1C is a perspective view of a printing consumable 100 provided by an embodiment of the present disclosure. FIG. 2 is an exploded view of the printing consumable 100 shown in FIG. 1A. According to an embodiment of the present disclosure, the printing consumable 100 may include a housing 1, a first spool core 3, a second spool core 2, a third spool core 4, an ink ribbon recovery wheel 5 and a receiving portion 6.

The housing 1 includes a first housing portion 11 and a second housing portion 12 that are relatively joined in a first direction F2. For example, in the specific example shown in FIGS. 1A and 2, the first direction F2 may be a thickness direction of the housing 1. In other embodiments, the first direction F2 may also be a length direction or the width direction of the housing 1.

A material of the first housing portion 11 includes but is not limited to plastic and metal. The first housing portion 11 includes a first wall plate 111 and a first side plate 112 disposed on an edge of the first wall plate 111 and extending toward the second housing portion 12.

The material of the second housing portion 12 includes but is not limited to plastic and metal. The second housing portion 12 includes a second wall plate 121 and a second side plate 122 disposed on an edge of the second wall plate 121 and extending toward the first housing portion 11. The second wall plate 121 and the first wall plate 111 are arranged opposite to each other in the first direction F2.

It may be understood that structures of the first housing portion 11 and the second housing portion 12 are not limited to this. In other embodiments, when the first housing portion 11 includes the first side plate 112, the second housing portion 12 may not include the second side plate 122; or, when the second housing portion 12 includes the second side plate 122, the first housing portion 11 may not include the first side plate 112.

An assembly relationship between the second housing portion 12 and the first housing portion 11 includes but is not limited to a snap-fitting manner or an embedding manner.

In this embodiment, by dividing the housing 1 into the first housing portion 11 and the second housing portion 12, and the first housing portion 11 and the second housing portion 12 are assembled together to form the housing 1, the processing and manufacturing process of the housing 1 is simplified, thereby facilitating the installation of the first spool core 3, the second spool core 2, the third spool core 4, or the like, in the housing 1.

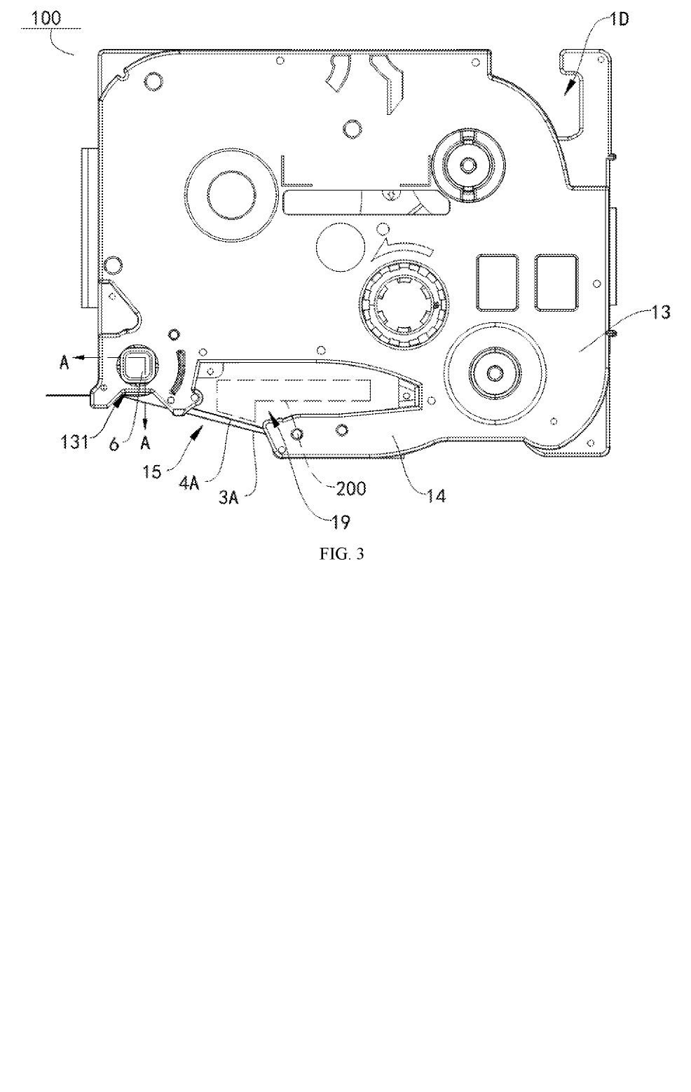

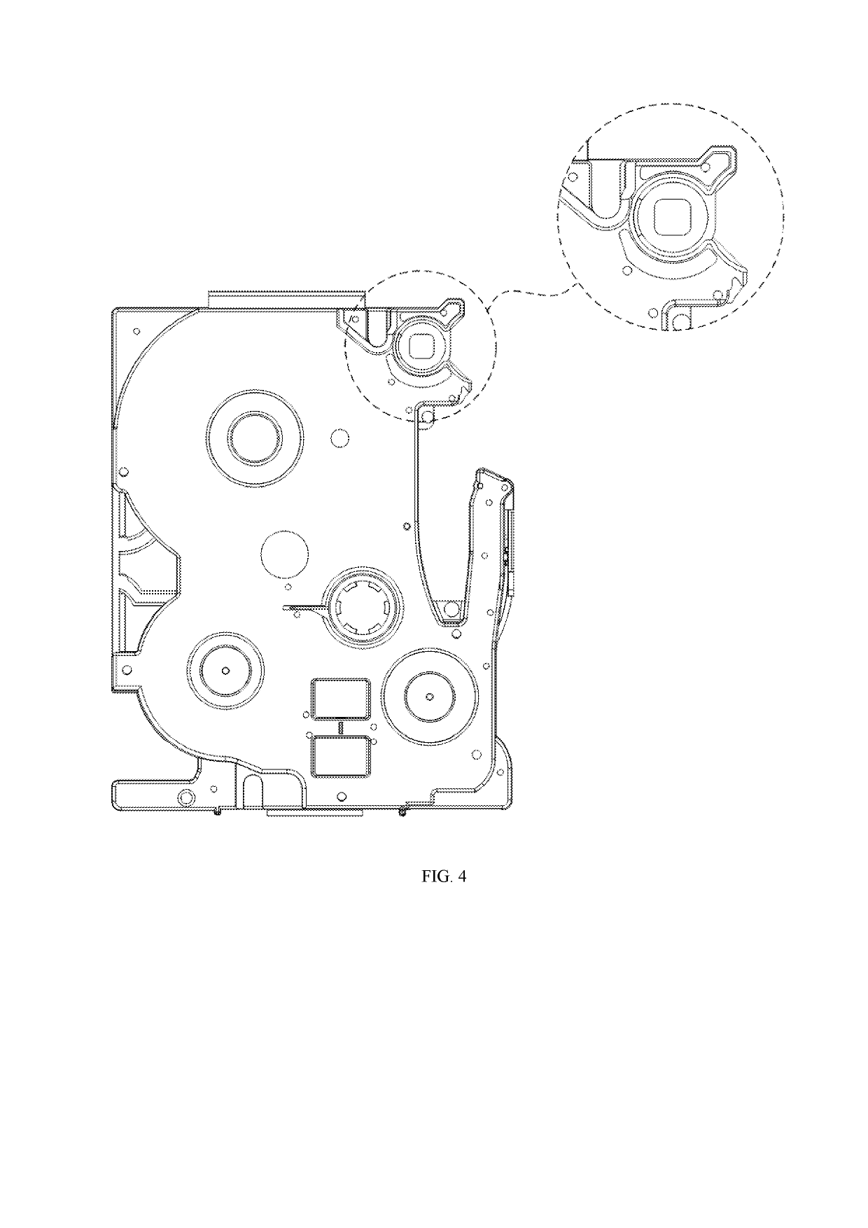

Please refer to FIGS. 3 and 4. FIG. 3 is a front view of the printing consumable 100 shown in FIG. 1A along the first direction F2. FIG. 4 is a rear view of the printing consumable 100 shown in FIG. 1A along the first direction F2. A printing head 200 in FIGS. 3 and 4 does not belong to the printing consumable 100 and is therefore drawn with a dashed line. The housing 1 has a mounting hole 19 that penetrates the housing 1 in the first direction F2. The mounting hole 19 extends to an outer peripheral edge of the housing 1 to form a main body 13 and a cantilever portion 14 connected to the outer peripheral surface of the main body 13. The cantilever portion 14 communicates with the main body 13. A mating area 15 is defined between a free end of the cantilever portion 14 and the main body 13.

Specifically, when the printing consumable 100 is installed in the printer main body, the printing head 200 is located in the mounting hole 19.

Certainly, it may be understood that in other embodiments, the housing 1 may not be provided with this mounting hole 19 for accommodating the printing head 200. For example, the printing head 200 may extend into the housing 1.

Please continue to refer to FIG. 2, and also refer to FIG. 5. FIG. 5 is a front view of a partial structure of the printing consumable 100 shown in FIG. 1A along the first direction F2, where the second housing portion 112 is not shown. The housing 1 has a first outlet 1B and a second outlet 1A.

The first spool core 3 is rotatably disposed in the housing 1. Specifically, the first spool core 3 is rotatably disposed in the main body 13. A rotation center line of the first spool core 3 extends along the first direction F2.

The first spool core 3 is wound with a first ribbon 3A. Specifically, in this example, the first ribbon 3A may be a ribbon, a flat sleeve or a film. The first outlet 1B is used for the first ribbon 3A released from the first spool core 3 to pass through. That is to say, the first ribbon 3A released from the first spool core 3 may pass through the first outlet 1B and extend to the outside of the housing 1.

The second spool core 2 is rotatably disposed in the housing 1. Specifically, the second spool core 2 is rotatably released in the main body 13. A rotation center line of the second spool core 2 extends along the first direction F2.

The second spool core 2 is wound with a second ribbon 2A. Specifically, in this example, the second ribbon 2A is an adhesive ribbon. The second outlet 1A is used for the second ribbon 2A released from the second spool core 2 to pass through. That is to say, the second ribbon 2A released from the second spool core 2 may pass through the second outlet 1A and extend to the outside of the housing 1.

The third spool core 4 is rotatably disposed in the housing 1. Specifically, the third spool core 4 is rotatably disposed in the main body 13. A rotation center line of the third spool core 4 extends along the first direction F2.

The third spool core 4 is wound with an ink ribbon 4A. The first outlet 1B may also be used for the ink ribbon 4A released from the third spool core 4 to pass through. That is to say, the ink ribbon 4A released from the third spool core 4 may extend from the first outlet 1B to the outside of the housing 1. Certainly, it may be understood that in other embodiments, a third outlet spaced apart from the first outlet 1B may also be provided on the housing 1, for example, at the free end of the cantilever portion 14 mentioned above, so that the third outlet may be used for the ink ribbon 4A released from the third spool core 4 to pass through.

The ink ribbon recovery wheel 5 is rotatably disposed in the housing 1. A rotation center line of the ink ribbon recovery wheel 5 extends along the first direction F2. The ink ribbon recovery wheel 5 is used for winding the used ink ribbon 4A.

Please continue to refer to FIGS. 2 and 5. The housing 1 also has a recovery inlet 1C. The recovery inlet 1C is used for the used ink ribbon 4A to pass through. That is to say, the ink ribbon 4A after thermal transfer print with the first ribbon 3A may enter the housing 1 through the recovery inlet 1C, and is connected to the ink ribbon recovery wheel 5, and then be wound onto the ink ribbon recovery wheel 5.

The rotatable arrangement of the second spool core 2, the first spool core 3, the third spool core 4, and the ink ribbon recovery wheel 5 in the housing 1 is well known to those skilled in the art, and will not be repeated herein.

The receiving portion 6 is disposed on the housing 1. Specifically, the receiving portion 6 is relatively fixed to the housing 1.

A material of the receiving portion 6 includes but is not limited to plastic and metal. When the receiving portion 6 is the plastic, illustratively, the material of the receiving portion 6 is acrylonitrile butadiene styrene plastic (ABS).

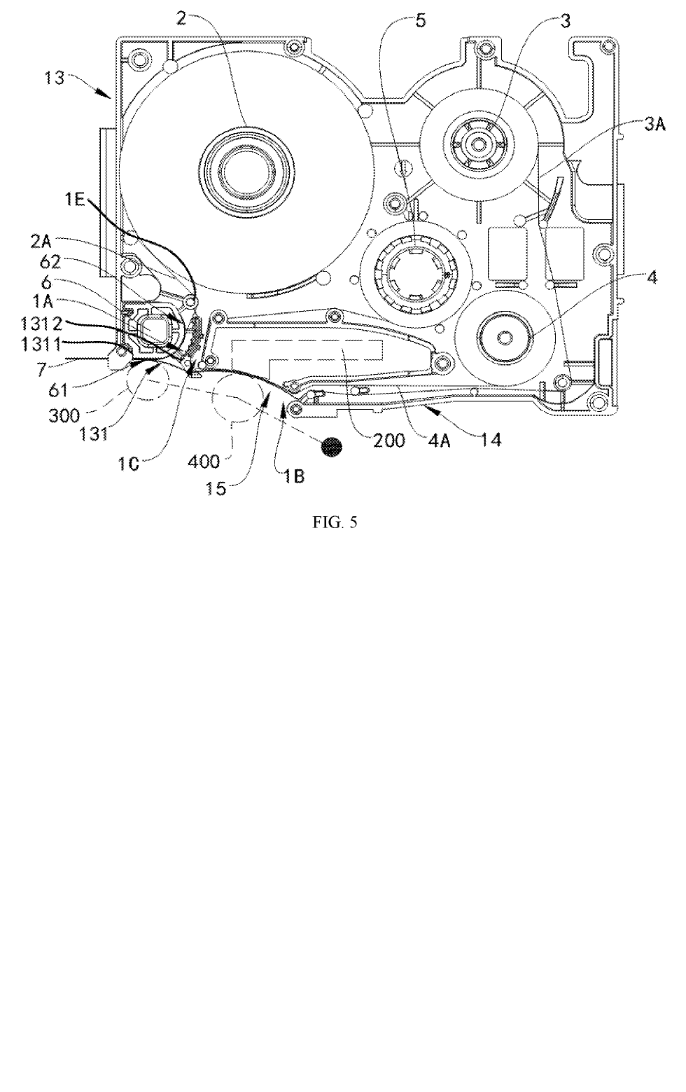

Please refer to FIGS. 5 and 6. FIG. 6 is a perspective view of the receiving portion 6 shown in FIG. 2. The receiving portion 6 has a receiving surface 61 exposed outside the housing 1. For example, the receiving surface 61 may be a plane or a curved surface.

When the printing consumable 100 is installed in the printer main body and the printer is operating, the ink ribbon recovery wheel 5, the impression wheel 400, and the first ribbon driving wheel 300 are rotated to pull the second ribbon 2A, the first ribbon 3A, and the ink ribbon 4A out of the housing 1. The printing head 200 cooperates with the impression wheel 400 at the mating area 15 to provide a clamping force for the unused first ribbon 3A and the ink ribbon 4A extending from the first outlet 1B, to achieve thermal transfer print between the unused first ribbon 3A and the ink ribbon 4A, thereby forming the first ribbon 3A carrying printing information. Driven by the impression wheel 400, the first ribbon driving wheel 300, and the ink ribbon recovery shaft, the used ink ribbon 4A enters the housing 1 through the recovery inlet 1C, and is wound onto the ink ribbon recovery wheel 5. At the same time, the first ribbon 3A carrying printing information and the second ribbon 2A move between the first ribbon driving wheel 300 and the receiving surface 61 of the receiving portion 6. The receiving surface 61 of the receiving portion 6 cooperates with the first ribbon driving wheel 300 to provide a clamping force for the first ribbon 3A carrying printing information and the second ribbon 2A, so that the first ribbon 3A carrying printing information and the second ribbon 2A are bonded into a finished ribbon 7. Driven further by the impression wheel 400 and the first ribbon driving wheel 300, the finished ribbon 7 is conveyed to the outside of the printer.

In the printing consumable 100 of the embodiment of the present disclosure, by providing the receiving portion 6 with the receiving surface 61 on the housing 1 of the printing consumable 100, and using the receiving surface 61 of the receiving portion 6 to cooperate with the first ribbon driving wheel 300 to provide the clamping force for the first ribbon 3A carrying printing information and the second ribbon 2A, the first ribbon 3A carrying printing information and the second ribbon 2A are bonded into the finished ribbon 7. Moreover, the first ribbon driving wheel 300 cooperates with the receiving surface 61 to convey the finished ribbon 7 carrying printing information to the outside of the printer. In this way, on one hand, the receiving portion 6 is used to improve the structural strength of the housing 1 and simplify the connection structure between the receiving portion 6 and the housing 1, and thus improving the assembly efficiency; and on the other hand, there is no requirement to reserve a movement space in the housing 1, which is conducive to reducing the size of the printing consumable 100 and realizing the miniaturization design of the printer.

In some embodiments of the present disclosure, a friction coefficient of the receiving surface 61 is less than a friction coefficient of an outer peripheral surface of the first ribbon driving wheel 300. In this way, it is beneficial to make a surface of the receiving surface 61 be relatively smooth, reducing the friction between the receiving surface 61 and the finished ribbon 7, thereby avoiding a problem of limited conveyance of the finished ribbon 7 to the outside of the printer due to the immobility of the receiving portion 6 relative to the housing 1.

Please continue to refer to FIG. 5, in some embodiments of the present disclosure, the second outlet 1A is disposed on a peripheral side wall of the main body 13. The first outlet 1B is located at the free end of the cantilever portion 14. The mating area 15 may be located between the second outlet 1A and the first outlet 1B, and the receiving portion 6 is located on a side of the second outlet 1A away from the mating area 15.

In this way, it facilitates shortening movement paths of the ink ribbon 4A, the first ribbon 3A, the second ribbon 2A, or the like, and thus improving the structural compactness of the printing consumable 100.

In some embodiments of the present disclosure, please continue to refer to FIG. 5. A peripheral side wall of the main body 13 has an opening 131. The opening 131 has a first wall surface 1311 and a second wall surface 1312 facing each other. The first wall surface 1311 and the second wall surface 1312 are spaced apart in a circumferential direction of the main body 13. The first wall surface 1311 is farther away from the second outlet 1A than the second wall surface 1312. The receiving portion 6 is located at the opening 131 and is arranged closer to the first wall surface 1311 relative to the second wall surface 1312. The second outlet 1A is defined between the receiving portion 6 and the second wall surface 1312, and the receiving surface 61 is exposed through the opening 131. In this way, the structure is simple.

In some specific examples, please refer to FIGS. 5 and 6, a surface of the receiving portion 6 close to the second wall surface 1312 is a guide convex curved surface 62. The guide convex curved surface 62 is connected to the receiving surface 61. The guide convex curved surface 62 is used for guiding the second ribbon 2A to the receiving surface 61. In this way, the reliability of the movement of the second ribbon 2A is improved.

For example, the guide convex curved surface 62 may be an arc surface. Therefore, the structure is simple and easy to process and manufacture. In other embodiments, the guide convex curved surface 62 may also be an elliptical arc surface.

For example, the guide convex curved surface 62 is tangent to the receiving surface 61. Thus, a junction between the guide convex curved surface 62 and the receiving surface 61 is smooth, which avoids a problem of scraping the second ribbon 2A and is conducive to the smooth movement of the second ribbon 2A.

Please continue to refer to FIG. 5, a guide column 1E is provided on an inner surface of the first wall plate 111 or the second wall plate 121. The guide column 1E is located on a side of the guide convex curved surface 62 close to the second wall surface 1312 and on a side of the receiving portion 6 opposite to the receiving surface 61. After the second ribbon 2A passes around a side of the guide column 1E away from the guide convex curved surface 62, it extends toward the guide convex curved surface 62. In this way, the setting of the guide column 1E helps reduce a contact area between the second ribbon 2A and the guide convex curved surface 62, thereby reducing the friction between them, and thus improving the reliability of the movement of the second ribbon 2A.

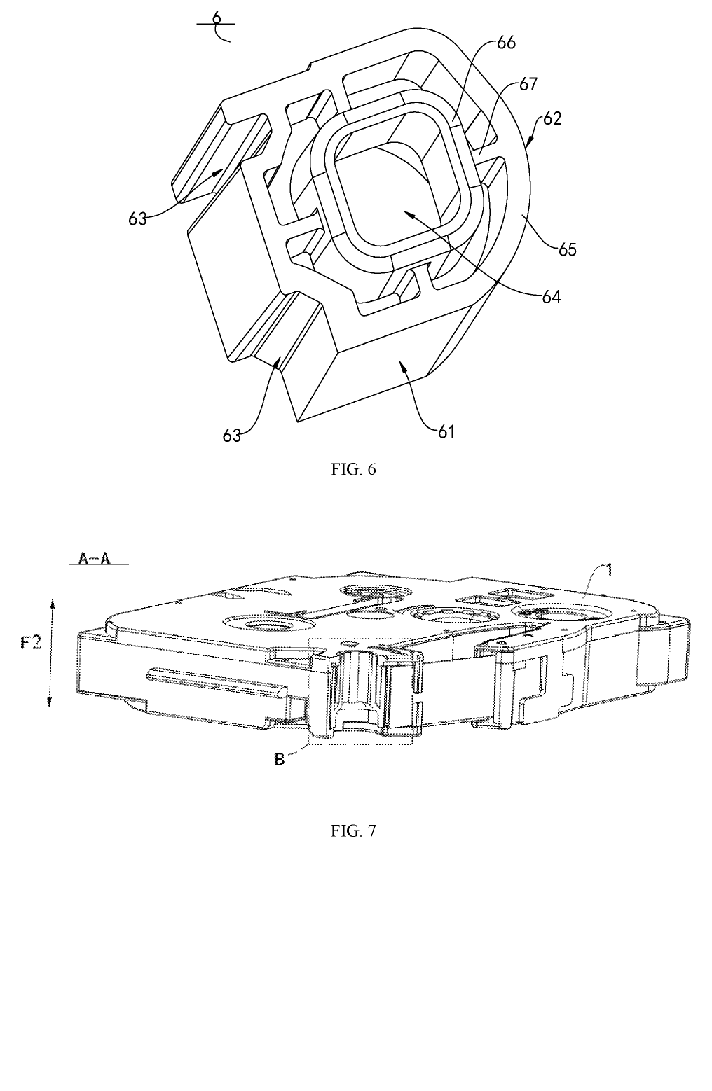

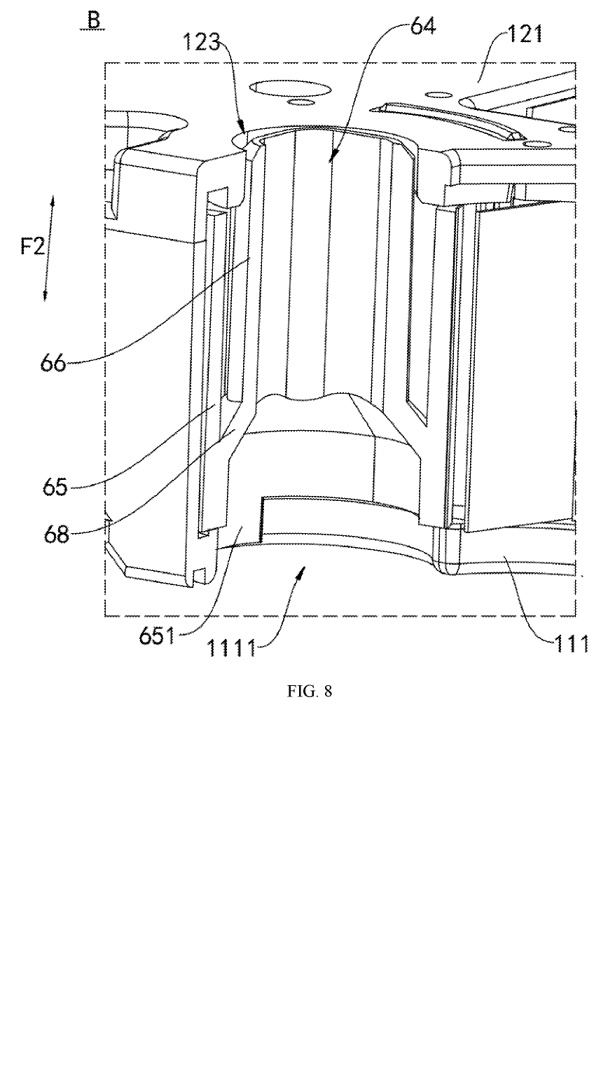

In some embodiments of the present disclosure, please refer to FIGS. 7 and 8. FIG. 7 is a cross-sectional view of the printing consumable 100 shown in FIG. 3 taken along a line A-A; FIG. 8 is an enlarged view of a portion circled at B in a structure shown in FIG. 7. The first wall plate 111 has a first clearance hole 1111 penetrating through the first wall plate 111 along the first direction F2. A shape of the first clearance hole 1111 includes but is not limited to a rectangular, a circular, an elliptical, or an irregular.

The receiving portion 6 has a second clearance hole 64 penetrating through the receiving portion 6 along the first direction F2. A shape of the second clearance hole 64 includes but is not limited to a rectangular, a circular, an elliptical, or an irregular.

The second clearance hole 64 and the first clearance hole 1111 are directly facing each other in the first direction F2. When the printing consumable 100 is installed in the printer main body, both the first clearance hole 1111 and the second clearance hole 64 are used for providing clearance for a ribbon driving shaft in the printer main body, so that the ribbon driving shaft is located in the first clearance hole 1111 and/or the second clearance hole 64. In this way, while being adaptable to printers with a ribbon driving shaft in related technologies, it may also be adapted to the printer in the present disclosure that reduces the ribbon driving shaft. The printer in the present disclosure reduces the use of the ribbon driving shaft and its gears, so that the structural compactness of the printer main body is improved and the loss of output power of the driving motor is reduced, thereby improving the adaptability of the printing consumable, and thus facilitating the iteration of the printer.

It may be understood that, to provide clearance for the ribbon driving shaft, when the ribbon driving shaft is partially located in the first clearance hole 1111 and partially in the second clearance hole 64, there are gaps between the ribbon driving shaft and the wall of the first clearance hole 1111, as well as between the ribbon driving shaft and the wall of the second clearance hole 64.

In some specific examples, please continue to refer to FIG. 8 and also refer to FIG. 6, the receiving portion 6 includes a first sleeve 65, a second sleeve 66 and a connecting rib 67.

An outer peripheral surface of the first sleeve 65 has the receiving surface 61 and the aforementioned guide convex curved surface 62. The second sleeve 66 is located in the first sleeve 65 and is spaced apart from the first sleeve 65. The second sleeve 66 forms a portion of the second clearance hole 64. The connecting rib 67 is connected between the first sleeve 65 and the second sleeve 66. In this way, the first sleeve 65 and the second sleeve 66 are spaced apart and are connected with the connecting rib 67, which not only simplifies the structure but also helps reduce the material usage of the receiving portion 6, thereby decreasing an overall weight of the printing consumable 100, and thus transportation and production costs are reduced.

For example, there may be a plurality of connecting ribs 67. The plurality of connecting ribs 67 are spaced apart along a circumferential direction of the second sleeve 66. In this way, it is beneficial to improve the connection reliability between the first sleeve 65 and the second sleeve 66. In the specific example shown in FIG. 6, there are four connecting ribs 67. In other examples, the connecting ribs 67 may also be two, three, five, or six.

For example, the first sleeve 65, the second sleeve 66, and the connecting rib 67 may be an integrally formed component. In this way, it is beneficial to improve the structural strength of the receiving portion 6 and simplify a processing technology of the receiving portion 6, and thus reducing manufacturing costs. In other embodiments, the connection methods between the first sleeve 65 and the connecting rib 67, as well as between the second sleeve 66 and the connecting rib 67, may also include a snap-fitting manner, a screw connection manner, or an adhesive bonding manner.

Please continue to refer to FIG. 8, the receiving portion 6 also includes a guide cylinder 68. The guide cylinder 68 is connected between an end of the second sleeve 66 close to the first clearance hole 1111 and the inner peripheral wall surface of the first sleeve 65. In a direction from the first clearance hole 1111 to the second sleeve 66, an area of an inner peripheral surface of the guide cylinder 68 gradually increases. In this way, a guiding effect of the guide cylinder 68 is utilized to allow the ribbon driving shaft to extend into the second clearance hole 64.

The guide cylinder 68 forms another portion of the second clearance hole 64.

For example, an inner peripheral surface of the guide cylinder 68 may be frustum-shaped or prism-shaped.

For example, the first sleeve 65, the second sleeve 66, and the guide cylinder 68 may be an integrally formed component. In this way, it is beneficial to improve the structural strength of the receiving portion 6 and simplify the processing technology of the receiving portion 6, and thus reducing the manufacturing costs. In other embodiments, the connection methods between the first sleeve 65 and the guide cylinder 68, as well as between the second sleeve 66 and the guide cylinder 68, may also include a snap-fitting manner, a screw connection manner, or an adhesive bonding manner.

It may be understood that, in other embodiments, the guide cylinder 68 may not be provided in the receiving portion 6. In this case, the second clearance hole 64 may be formed by the second sleeve 66. Furthermore, the structure of the receiving portion 6 is not limited to this. In other embodiments, the receiving portion 6 may only include the first sleeve 65, and the first sleeve 65 defines the second clearance hole 64.

On this basis, please continue to refer to FIG. 8. The first sleeve 65 is clamped between the first wall plate 111 and the second wall plate 121. In this way, the clamping force of the first wall plate 111 and the second wall plate 121 may restrict the movement of the receiving portion 6 in the first direction F2.

Please continue to refer to FIG. 8. In some embodiments, a limiting plate 651 is provided on an end surface of the first sleeve 65 facing the first wall plate 111. The limiting plate 651 is located in the first clearance hole 1111 and cooperates with the wall of the first clearance hole 1111 for limiting. In this way, by utilizing the cooperation between the limiting plate 651 and the wall of the first clearance hole 1111, the movement of the receiving portion 6 in a direction perpendicular to the first direction F2 is restricted to some extent.

For example, the limiting plate 651 and the first sleeve 65 may be an integrally formed component. In this way, it is beneficial to improve the connection strength between the limiting plate 651 and the first sleeve 65 and simplify their processing technology, and thus reducing manufacturing costs. In other embodiments, the connection method between the limiting plate 651 and the first sleeve 65 may also include a snap-fitting manner, a screw connection manner, or an adhesive bonding manner.

For example, a shape of the limiting plate 651 includes but is not limited to a rectangular, a triangular, or an arc extending along a circumferential direction of the first clearance hole 1111.

Please continue to refer to FIG. 8. In some embodiments, the second wall plate 121 has a limiting hole 123. An end of the second sleeve 66 away from the first clearance hole 1111 is limited in the limiting hole 123. In this way, by utilizing the limiting cooperation between the second sleeve 66 and the second clearance hole 64, the movement of the receiving portion 6 in a direction perpendicular to the first direction F2 is further restricted.

For example, a shape and size of the limiting hole 123 are the same as an outer peripheral contour of the second sleeve 66. In this way, it is beneficial to improve their compatibility. For example, a diameter of the limiting hole 123 is greater than a diameter of the second sleeve 66, facilitating the installation of the second sleeve 66 into the limiting hole 123. Alternatively, a guide surface (not shown) is provided at an end of the second sleeve 66 away from the first clearance hole 1111, making it convenient for the second sleeve 66 to be inserted into the limiting hole 123.

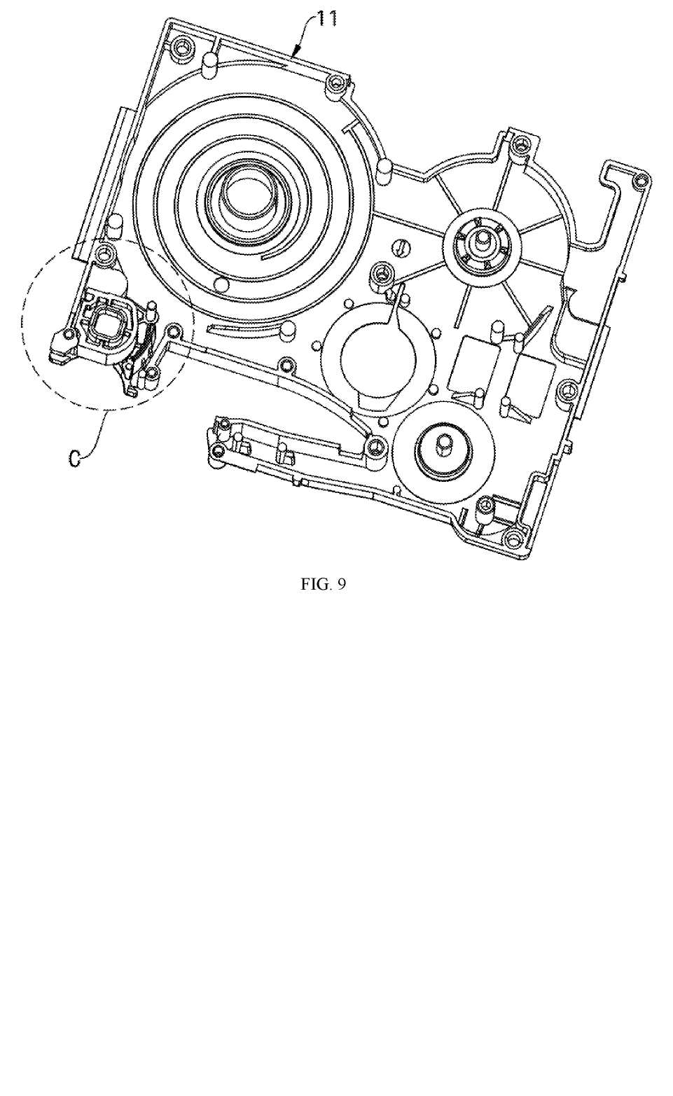

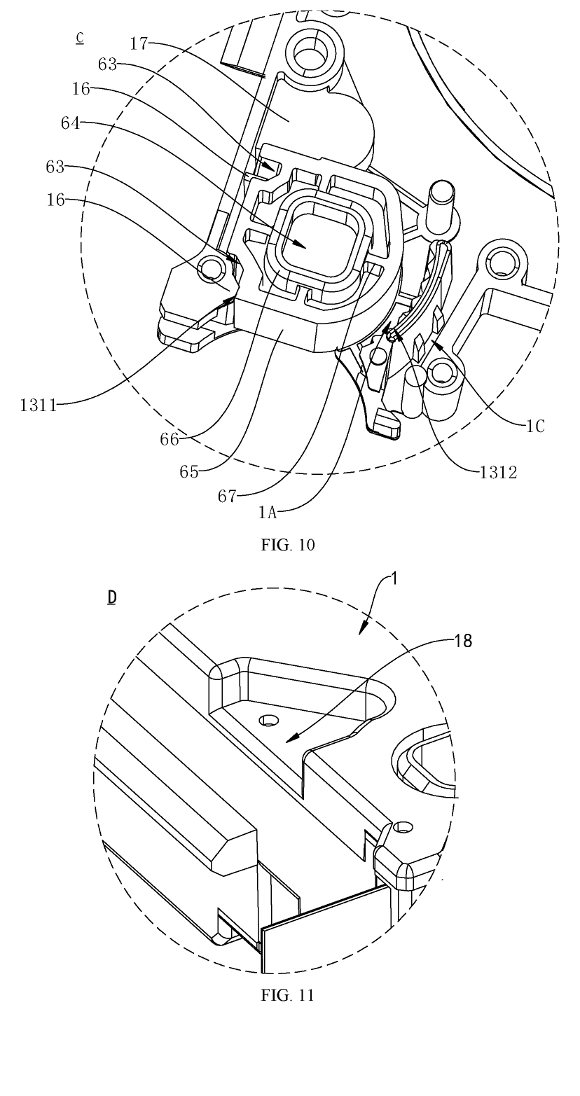

Please refer to FIGS. 9 and 10. FIG. 9 is a perspective view of the first housing 1 shown in FIG. 2. FIG. 10 is an enlarged view of a portion circled at C in the first housing 1 shown in FIG. 9. An outer peripheral surface of the first sleeve 65 is provided with a first positioning structure 63. An inner surface of the housing 1 is provided with a second positioning structure 16. The first positioning structure 63 is one of a groove and a protrusion, and the second positioning structure 16 is the other of the groove and the protrusion. The protrusion fits into the groove. In the specific example shown in FIG. 10, the first positioning structure 63 is the groove, and the second positioning structure 16 is the protrusion.

In this way, on one hand, the cooperation between the first positioning structure 63 and the second positioning structure 16 will provide a pre-positioning function for the assembly of the receiving portion 6 and the housing 1, thereby improving assembly efficiency. On the other hand, since there is an abutting force between the receiving portion 6 and the first ribbon driving wheel 300, and the guide convex curved surface 62 guides the second ribbon 2A, there is also a certain abutting force between the guide convex curved surface 62 and the second ribbon 2A. The cooperation between the first positioning structure 63 and the second positioning structure 16 prevents the receiving portion 6 from moving in a direction perpendicular to the first direction F2 due to the abutting force.

On this basis, please continue to refer to FIG. 10. The first positioning structure 63 is provided on a surface on a side of the first sleeve 65 facing away from the guide convex curved surface. In this way, the receiving portion 6 is effectively prevented from moving in the direction perpendicular to the first direction F2 caused by the abutting force from the second ribbon 2A.

For example, there may be a plurality of first positioning structures 63 and second positioning structures 16. The plurality of first positioning structures 63 and the plurality of second positioning structures 16 are in one-to-one correspondence and cooperate with each other.

Please continue to refer to FIG. 10. An inner surface of the first wall plate 111 and/or the second wall plate 121 is provided with a protruding portion 17. It may be understood that, a setting position of the protruding portion 17 is not limited to this. In other embodiments, the protruding portion 17 may also be provided on the aforementioned first side plate 112 and/or second side plate 122, as long as the protruding portion 17 is provided on the inner surface of the housing 1.

The protruding portion 17 is located on a side of the receiving portion 6 facing away from the receiving surface 61. The protruding portion 17 is configured to cooperate with the receiving portion 6 to restrict deformation of the receiving portion 6 toward the side where the protruding portion 17 is located. Specifically, the clamping force between the first ribbon driving wheel 300 and the receiving surface 61 will cause the receiving portion 6 to have a tendency to move and deform in a direction away from the first ribbon driving wheel 300. The provision of the protruding portion 17 may be used for restricting the movement and deformation of the printing consumable 100 in the direction away from the first ribbon driving wheel 300 during long-term use, so that it is beneficial to improving the cooperation reliability between the receiving portion 6 and the first ribbon driving wheel 300.

A shape of the protruding portion 17 includes but is not limited to cuboid, cylinder, or irregular.

Please refer to FIG. 11. FIG. 11 is an enlarged view of a portion circled at D in the printing consumable 100 shown in FIG. 1A. The formation of the aforementioned protruding portion 17 may be achieved by recessing from the outer surface of the housing 1 toward the interior of the housing 1. In this way, the protruding portion 17 is formed on the inner surface of the housing 1, and a recessed portion 18, having a shape similar to a shape of the protruding portion 17, is formed on the outer surface of the housing 1. As a result, an overall structural strength of the housing 1 is higher.

Please refer back to FIG. 3. The housing 1 has a positioning notch 1D penetrating through the housing 1 along the first direction F2. This positioning notch 1D is configured to cooperate with a positioning portion on the printer main body, thereby providing a positioning function for the assembly of the printing consumable 100 and the printer main body.

The present disclosure also provides a printing consumable. The difference between the printing consumable in this embodiment and the printing consumable in any of the above embodiments is that, in this embodiment, the printing consumable does not include the second spool core 2. In this case, the first ribbon 3A carrying printing information formed by thermal transfer print of the ink ribbon and the first ribbon 3A moves between the receiving portion 6 and the first ribbon driving wheel 300, is clamped by them, and is then continuously conveyed outside the printer under the rotation of the first ribbon driving wheel 300.

A printing consumable (that is, a ribbon cassette) is an object used for accommodating a ribbon (such as an ink ribbon and a printing ribbon, and the like) and is capable of being detachably installed on a printer main body. When the printing consumable is installed on the printer main body, a driving member on the printer main body cooperates with certain portions of the printing consumable to drive the ribbon to move, causing the ribbon inside the ribbon cassette to move to the mating area (that is, a printing port), so that the printing head on the printer performs printing on the ribbon at the mating area. If abnormal conditions such as folding, bulging, or floating outward occur during the movement of the ribbon, especially at a position close to the mating area, the printing effect will be affected.

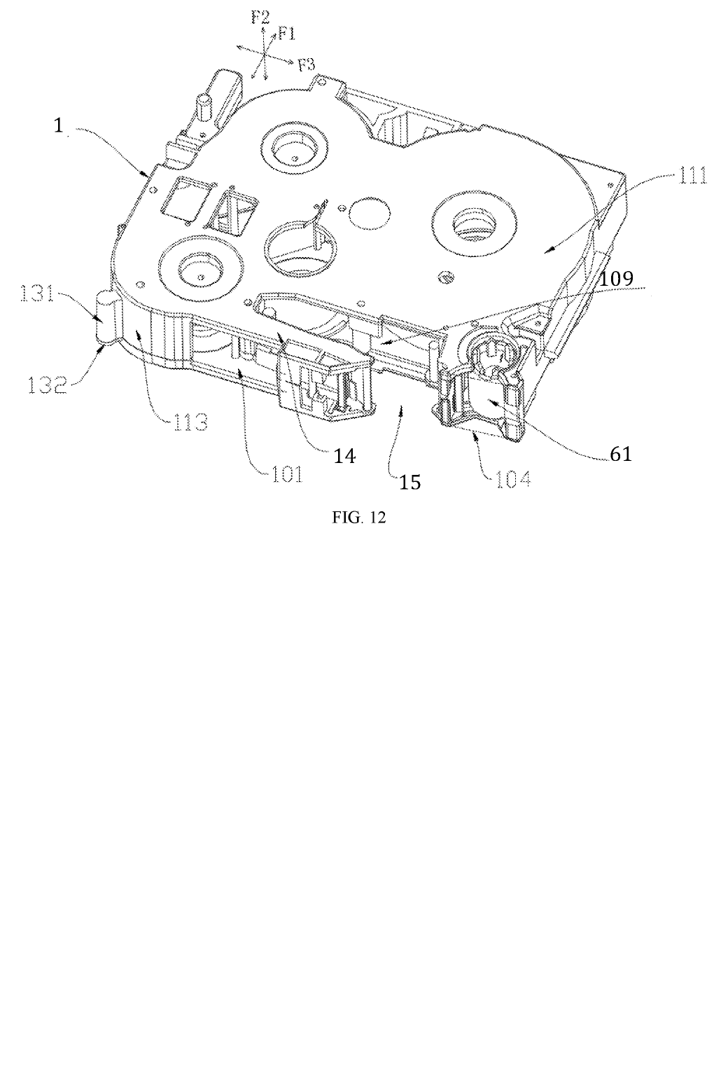

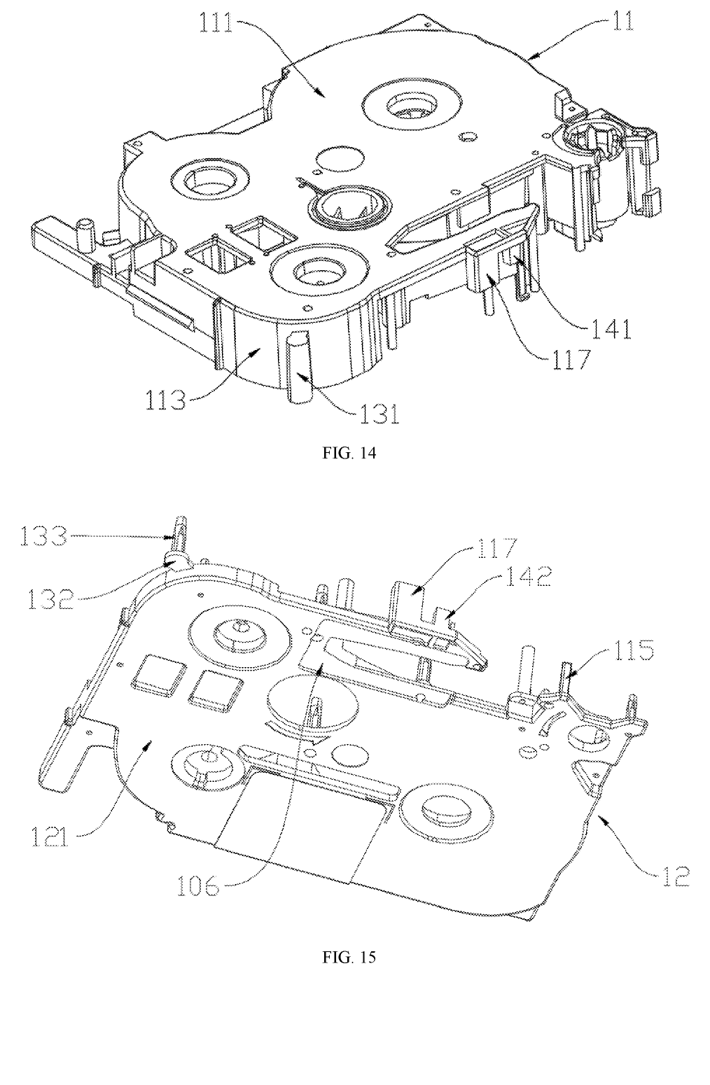

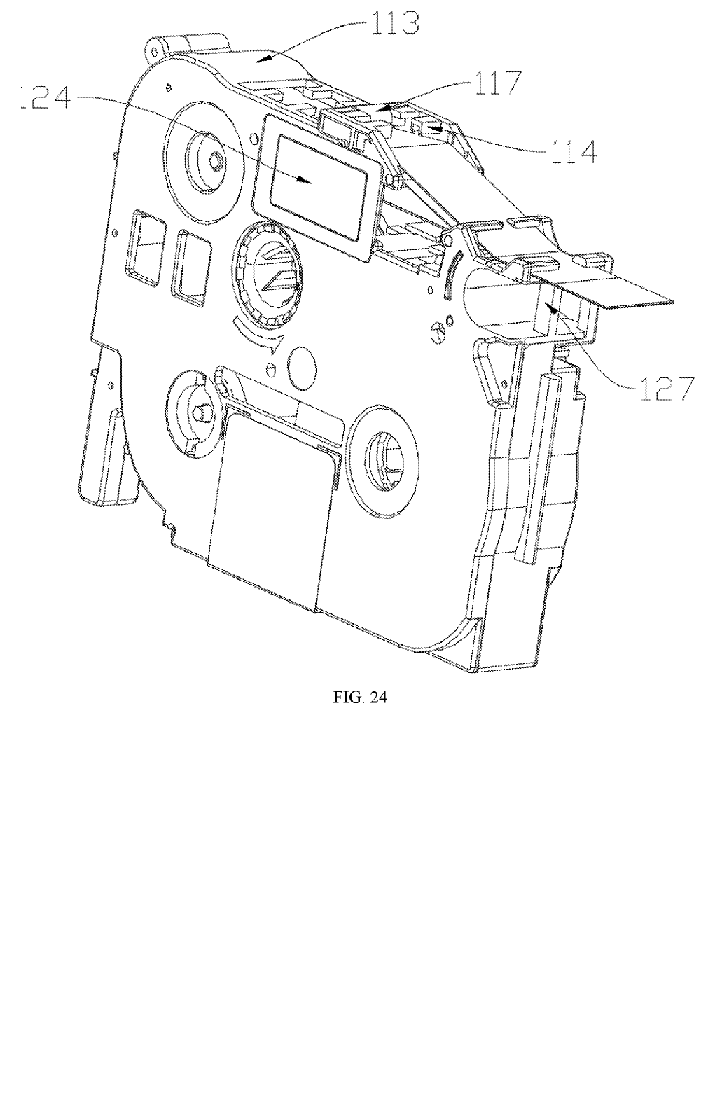

Please refer to FIGS. 12-24, the present disclosure provides a printing device (for example, a printer). The printer includes but is not limited to a thermal transfer printer, a label printer, a ticket printer, and a thermal printer.

The printer in the embodiments of the present disclosure includes a printer main body and a printing consumable 100. The printer main body has a receiving cavity for accommodating the printing consumable 100, and the printing consumable 100 is detachably installed on the printer main body. For example, a detachable connection method between the printing consumable 100 and the printer main body includes but is not limited to a snap-fitting manner.

The printer main body is also provided with a driver, a printing head 200, a ribbon pinch wheel 22, a transport wheel 23, and the like. The printing head 200 is located in the receiving cavity. The printing consumable 100 may be installed in the receiving cavity of the printer main body and may also be detached from the printer main body from the receiving cavity. The printing consumable 100 accommodates a ribbon therein. By replacing the printing consumable 100, the replenishment of the ribbon and the change of the ribbon type (size, color, material, or the like.) may be achieved. The main structure of the printer main body is well known to those skilled in the art. and will not be repeated herein.

The structure of the printing consumable of the present disclosure will be described in detail below.

The printing consumable 100 includes a housing 1. Spool shafts are disposed in the housing 1, and ribbons are accommodated in the housing 1 and are wound on the spool shafts. Depending on a type of the printing consumable 100, the number of the spool shafts and the number and type of the ribbons may vary. For example, the ribbons may be classified into a first ribbon 3A (that is, a printing ribbon), an ink ribbon 4A, and an adhesive ribbon. Correspondingly, the spool shafts may be classified into a printing ribbon spool shaft, an ink ribbon spool shaft, and an adhesive ribbon spool shaft. The first ribbon 3A is the ribbon on which printing content needs to be printed. It may be a paper ribbon, a film, or a fabric ribbon, or the like. The first ribbon 3A is wound on the printing ribbon spool shaft. The adhesive ribbon is wound on the adhesive ribbon spool shaft. The ink ribbon 4A (also called a carbon ribbon or a color ribbon) is wound on the ink ribbon spool shaft. Generally, two of the spool shafts are provided for winding the ink ribbon 4A. The first one is used for winding the unused ink ribbon 4A, and the second one is used for winding the used ink ribbon 4A. Generally, the first one is called the ink ribbon `spool shaft, and the second one is called the recovery spool shaft. In one type of the printing consumable, only the first ribbon 3A and the printing ribbon spool shaft are present. In another type of the printing consumable, the ink ribbon 4A, the ink ribbon spool shaft, the recovery spool shaft, the first ribbon 3A, and the printing ribbon spool shaft are present. In yet another type of the printing consumable, the ink ribbon 4A, the ink ribbon spool shaft, the recovery spool shaft, the first ribbon 3A, the printing ribbon spool shaft, the adhesive ribbon, and the adhesive ribbon spool shaft are present.

The housing 1 of the printing consumable 100 includes a first wall plate (that is, a top plate) 111, a second wall plate (that is, a bottom plate) 121, and a side plate 113. The first wall plate 111 and the second wall plate 121 are opposite to and spaced apart from each other in the first direction (the F2 direction shown in the drawings). The side plate 113 connects the first wall plate 111 and the second wall plate 121, and is located on contour edges of the first wall plate 111 and the second wall plate 121. Therefore, the first wall plate 111, the second wall plate 121, and the side plate 113 together form the housing 1 having an inner cavity.

In the present disclosure, an arrangement direction of the front end (an end where a mating area 15 is located) and a rear end of the housing 1 is recorded as a second direction (the F1 direction shown in the drawings). An arrangement direction of the first wall plate 111 and the second wall plate 121 is recorded as the first direction (the F2 direction shown in the drawings). Another direction perpendicular to the first direction and the second direction is a third direction (the F3 direction shown in the drawings).

Specifically, the housing 1 may be formed by combining a first housing portion (that is, a top cover) 11 and a second housing portion (that is, a bottom cover) 12 that are snap-fitted together. The first housing portion 11 and the second housing portion 12 are two components, and are snap-fitted together in the first direction F2 to form the housing 1 having the internal cavity. Both the first housing portion 11 and the second housing portion 12 may be integrally formed injection-molded parts. The first housing portion 11 includes the first wall plate 111. The second housing portion 12 includes the second wall plate 121. The side plate 113 may be integrally connected to the first wall plate 111 or the second wall plate 121. Alternatively, a local area of the side plate 113 is integrally connected to the first wall plate 111 and is located on the first housing portion 11, and another local area of the side plate 113 is integrally connected to the second wall plate 121 and is located on the second housing portion 12.

The housing 1 of the printing consumable is provided with a mounting hole 19 (that is, a printing mounting hole) for the printing head 200 to be embedded. An axial direction of the mounting hole 19 is parallel to the first direction F2. A local side wall of the housing 1 is missing to form the mating area 15 opened on the housing 1. In other words, the side plate 113 of the housing 1 is provided with the mating area 15, and the mating area 15 is connected to the mounting hole 19.

At the same time, the housing 1 is also provided with a ribbon outlet 109. The unprinted ribbon moves out of a shielded area or the inner cavity of the housing 1 from the ribbon outlet 109 and is exposed from the housing 1. After being discharged from the ribbon outlet 109, the ribbon continues to move to the mating area 15. The mating area 15 is used for exposing a local section of the ribbon at the printing head embedded in the mounting hole 19 to achieve printing.

The housing 1 is also provided with a receiving surface 61. For example, a certain portion of the housing 1 is exposed to the outside and forms the receiving surface 61. After passing through the mating area 15, the ribbon passes an outer side of the receiving surface 61 and covers at least a portion of the receiving surface 61.

When the printing consumable is placed into the receiving cavity, the printing head 200 is inserted into the mounting hole 19, and its printing area faces toward a section of the ribbon (a certain segment of the ribbon) exposed at the mating area 15. The ribbon pinch wheel 22 presses the ribbon against the printing head 200 from an outer side of the ribbon on the mating area 15. The transport wheel 23 is opposite to the receiving surface 61 and presses a section of the ribbon between them against the receiving surface 61. Please refer to FIG. 2. FIG. 2 is a schematic diagram of the cooperation between the printing consumable and the components on the printer main body. Among them, the printing head 200, the ribbon pinch wheel 22, and the transport wheel 23 all belong to the components of the printer main body, and are shown with dashed lines in the figure. A driver of the printer main body is connected to a certain spool shaft on the printing consumable and drives this spool shaft to rotate, while transmitting power to the transport wheel 23. Driven jointly by the spool shaft connected to the driver and the transport wheel 23, the ribbon in the ribbon cassette moves along a predetermined supply path, and then is discharged from the ribbon outlet 109 on the housing 1 and moves to the mating area 15. The printing head 200 then prints the printing content onto the ribbon.

The printed ribbon may serve as a printing finished product. For example, when the printing consumable only contains the first ribbon 3A, the first ribbon 3A is made of thermal-sensitive material. When the first ribbon 3A passes through the mating area 15, the printing head 200 heats it to display the printing content on the first ribbon 3A. When the ribbons in the printing consumable include the first ribbon 3A and the ink ribbon 4A, the first ribbon 3A and the ink ribbon 4A are stacked at the ribbon outlet 109 (the ink ribbon 4A is on the inner side, and the first ribbon 3A is on the outer side) and move to the mating area 15 in a stacked state. The printing head 200 and the ribbon pinch wheel 22 then press the ink ribbon 4A and the first ribbon 3A at the mating area 15 for printing. After printing, the first ribbon 3A is separated from the ink ribbon 4A. The ink ribbon 4A is guided and wound onto the recovery spool shaft in the housing 1. This section of the first ribbon 3A with printing content serves as the printing finished product.

Alternatively, when the ribbons in the printing consumable include a first ribbon 3A, an ink ribbon 4A, and an adhesive ribbon, the first ribbon 3A and the ink ribbon 4A are still stacked and pass through the mating area 15. The printed ink ribbon 4A is wound onto the recovery spool, while the first ribbon 3A continues moving and, together with the adhesive ribbon, passes over the receiving surface 61. The first ribbon 3A and the adhesive ribbon are stacked at the receiving surface 61. The transport wheel 23 presses the stacked first ribbon 3A and adhesive ribbon to make them be bonded together. Therefore, this section of the first ribbon 3A with printed content and the adhesive ribbon are combined to form the finished ribbon.

In related technologies, during the movement of the ribbon, phenomena such as wrinkles, local folds, and bulging sometimes occur. Especially when the ribbon segment close to the mating area 15 experiences misalignment phenomena like folding, bulging, or floating outward, it will affect the printing effectiveness.

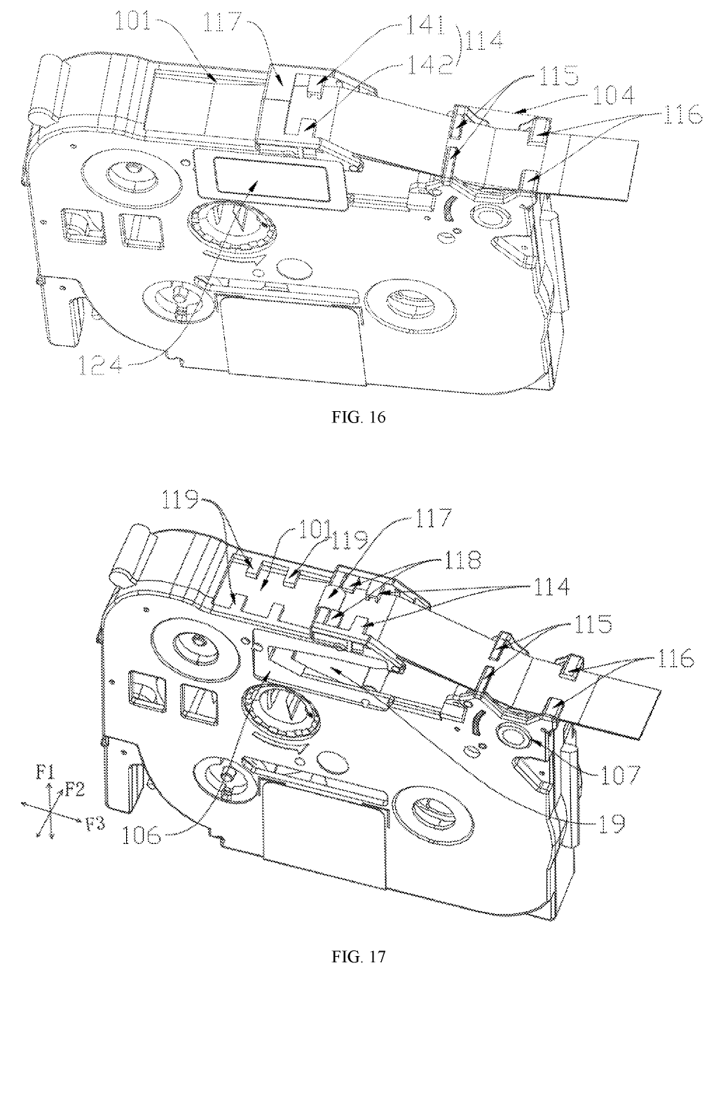

Based on this, to solve the aforementioned technical problem, please refer to FIGS. 16-19. The housing 1 of the printing consumable provided in this disclosure is also provided with a first opening 101. The first opening 101 is provided on the side plate 113 and exposes a portion of the ribbon. The first opening 101 is located on a side of the mating area 15 facing the upstream of the ribbon supply path. A first limiting member 114 is provided at the first opening 101, covering a portion of the first opening 101. The first limiting member 114 is located on an outer side of the ribbon in the second direction F1 (that is, the thickness direction of the ribbon).

According to the printing consumable provided by the present disclosure, not only the mating area 15 is provided on the side plate 113 of the housing 1 to expose the ribbon for printing, but also a first opening 101 is also provided on the upstream of the mating area 15 to expose a portion of the ribbon. In this way, the ribbon will be visually observed before it reaches the mating area 15, allowing inspection for any abnormal movement that might cause ribbon loosening such as wrinkles or bulging. Simultaneously, the internal condition of the printing consumable will also be observed through this first opening 101, facilitating checking a remaining ribbon amount, a ribbon type, or the like. Furthermore, by providing the first limiting member 114 at the first opening 101, the ribbon is limited, thereby preventing its offset in the second direction F1 during moving. By using the first limiting member 114 to restrain the ribbon, it will effectively prevent misalignment and loosening conditions such as bulging or floating outward in the ribbon segment about to enter the mating area 15, thereby improving the printing effectiveness.

For example, the first opening 101 communicates with the mating area 15. Then, a starting point of the first opening 101 on the ribbon supply path forms a ribbon outlet 109. After exiting from the ribbon outlet 109, the ribbon is visually observed and then moves to the mating area 15.

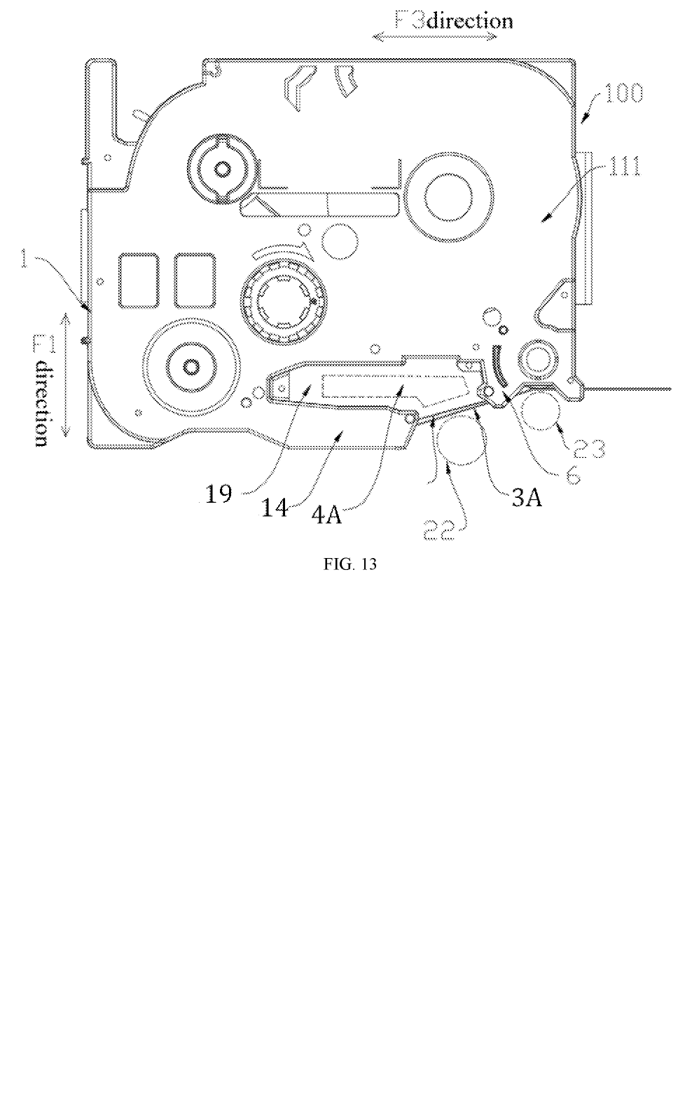

For example, as shown in FIG. 13, the housing 1 of the printing consumable as a whole may include a main body portion and a cantilever portion 14 (that is, an arm portion) extending from the main body portion. The cantilever portion 14 protrudes outward from the main body portion and then extends in the direction of the ribbon supply path. For instance, the cantilever portion 14 protrudes outward from a side of the main body portion in the second direction F1 along the second direction F1, and extends along the third direction. The cantilever portion 14 extends from a first end of the main body portion in the third direction towards a second end.

A receiving portion 6 for cooperating with the transport wheel 23 may also be formed on the main body portion. The receiving surface 61 is formed on this receiving portion 6. There is a gap between a distal end of the cantilever portion 14 and the receiving portion 6, and this gap forms the mating area 15. The gap between the cantilever portion 14 and the main body portion forms a mounting hole 19. In other words, a space enclosed by the cantilever portion 14, the main body portion and the receiving portion 6 forms the mounting hole 19.

The cantilever portion 14 is used for guiding the ribbon towards the mating area 15. The interior of the cantilever portion 14 has a guide structure for guiding the ribbon along the ribbon supply path.

The first opening 101 may be provided on the cantilever portion 14. For example, the cantilever portion 14 is formed by a portion of the first wall plate 111, a portion of the second wall plate 121 and a portion of the side plate 113. This portion of the side plate 113 forms a front surface of the cantilever portion 14. The first opening 101 is formed on this portion of the side plate 113, that is, it is opened on the front surface of the cantilever portion 14, thereby exposing the ribbon segment about to proceed to the mating area 15.

The first limiting member 114 may be a column, a plate structure or a block.

For example, the first limiting member 114 includes only one limiting portion, such as a first limiting portion 141. The first limiting portion 141 extends along the first direction F2. For instance, it may extend from a side edge of the first opening 101 in the first direction F2 to the other side edge of the first opening 10, or, it may extend to connect to the other side edge or have a gap from it.

Alternatively, the first limiting member 114 includes two limiting portions, such as a first limiting portion 141 and a second limiting portion 142. Projections of the first limiting portion 141 and the second limiting portion 142 in the second direction F1 are at least partially located at different positions in the first direction F2, for example, they are at least partially non-overlapping or arranged in a staggered manner. That is, the first limiting portion 141 and the second limiting portion 142 are located at different positions in the first direction F2. For example, they may be staggered and spaced apart from each other, or opposite to and spaced apart from each other, or the like. For example, the first limiting portion 141 and the second limiting portion 142 are spaced apart from and opposite to each other in the first direction F2. The term "staggered" herein means that in the first direction F2, the first limiting portion 141 and the second limiting portion 142 are at different positions, and simultaneously, in the third direction, they are at different positions. The term "Opposite" herein means that in the first direction F2, the first limiting portion 141 and the second limiting portion 142 are at different positions, but simultaneously, in the third direction, they are at the same position.

The first limiting portion 141 and the second limiting portion 142 restrain the ribbon in the second direction F1 perpendicular to a ribbon surface, thereby preventing bulging and limiting the ribbon.

Simultaneously, there is a gap between the two limiting portions. This gap may form an installation position to accommodate and install other components. For example, a rolling member, a ball, or a roller that contacts with the ribbon surface, which is used for gently smoothing the ribbon surface, thereby flattening the ribbon surface, and thus preventing wrinkles of the ribbon. In other words, the installation position may be used for installing a ribbon flattening member, which is used for flattening the ribbon surface and preventing wrinkles of the ribbon.

The first limiting member 114 covers only a small area of the first opening 101 and does not affect the function of the first opening 101 as a viewing window. Meanwhile, the first limiting member 114 effectively extends in a width direction of the ribbon, thereby ensuring its limiting effect on the ribbon.

The limiting portion may be a column structure, a block structure or a plate structure. For illustrative purposes only, the block structure refers to all standard or non-standard block-like structures, and the column structure refers to a block-like structure where width and thickness dimensions thereof are not significantly different, but a length dimension thereof may (not necessarily) be greater than the width and thickness dimensions thereof, and it may also have a hollow interior. A cross-sectional contour of the column may be a circular or an elliptical, or a polygonal such as a square, a rectangular, a pentagonal, a concave shape, or the like. The plate structure refers to a thin-sheet structure where a thickness thereof is significantly less than length and width dimensions thereof. A contour of the plate surface may be a circular, a square, a rectangular, a polygonal, or the like, or a shape that is partially straight and partially wavy.

Regardless of whether the first limiting member 114 includes one or two limiting portions, a recess cavity may be provided on the limiting portion, as shown in the limiting portion in FIG. 16. When the first limiting member 114 includes the first limiting portion 141 and the second limiting portion 142, a recess cavity may be provided on the first limiting portion 141 and/or the second limiting portion 142. For example, only the first limiting portion 141 is provided with a first recess cavity. The first recess cavity has at least one cavity opening facing outward from the first limiting portion 141 in the second direction F1. Therefore, the first recess cavity may be used for installing and fixing a component, allowing the component to be mounted at the first opening 101; or, only the second limiting portion 142 is provided with a second recess cavity communicating with a space between the two limiting portions. Alternatively, the first limiting portion 141 is provided with a first recess cavity, and the second limiting portion 142 is provided with a second recess cavity. Both the first recess cavity and the second recess cavity communicate with the space between the two limiting portions. Both the first recess cavity and the second recess cavity may be used for installing components that extend beyond the limiting portion. Simultaneously, the arrangement of the cavity also facilitates manufacturing and prevents a sink mark on the limiting portion. Therefore, regardless of how many limiting portions the first limiting member 114 has, a recess cavity may be optionally provided on any one or multiple limiting portions, to form a hollow structure in the limiting portion, which may be used for installing the component that needs to extend beyond the limiting portion, such as a ribbon flattening member.

There may be one or a plurality of the first limiting members 114. When the plurality of the first limiting members 114 are provided, they can be arranged along the ribbon supply path.

Please refer to FIGS. 12 and 16. A second opening 104 (as indicated by the dashed boxes in FIGS. 12 and 16) may also be provided on the housing 1 to expose a portion of the ribbon. A second limiting member 115 is provided at the second opening 104. The second opening 104 and the second limiting member 115 are located on a side of the mating area 15 facing the downstream of the ribbon supply path. The first limiting member 114 and the second limiting member 115 are located upstream and downstream of the mating area 15, respectively. In this way, the ribbon segment at the mating area 15 is limited at both its front and rear ends by the limiting members, thereby effectively ensuring that the ribbon segment at the mating area 15 is flat and does not experience floating phenomena such as bulging or folding.

For example, in the structure where the housing 1 has a main body portion, a cantilever portion 14 and a receiving portion 6, the second opening 104 is provided on the receiving portion 6. The second opening 104 contains the receiving surface 61 and is used for exposing the ribbon segment located on an outer side of the receiving surface 61. When the printing consumable is installed into the printer main body, the transport wheel 23 is capable of directly pressing this ribbon segment against the receiving surface 61.

Furthermore, a third limiting member 116 may also be provided on the housing 1. The third limiting member 116 is also located at the second opening 104 and covers a portion of the second opening 104. The second limiting member 115 and the third limiting member 116 are spaced apart from each other along the ribbon moving direction. The third limiting member 116 may be located on the side of the second limiting member 115 facing the downstream of the ribbon supply path. Along the ribbon supply path, the second limiting member 115 and the third limiting member 116 may be distributed on the upstream and downstream sides of the receiving surface 61, respectively. This also helps ensure the flatness of the ribbon segment passing over the receiving surface 61.

The second limiting member 115 may have only one limiting portion, such as a third limiting portion, or it may include two limiting portions spaced apart from and opposite to each other in the first direction F2, such as a third limiting portion and a fourth limiting portion. A gap between the third limiting portion and the fourth limiting portion may also form an installation site which may also be used for installing components that is capable of contacting with the ribbon surface to flatten the ribbon.

The third limiting member 116 may have only one limiting portion, such as a fifth limiting portion, or it may include two limiting portions spaced apart from and opposite to each other in the first direction F2, such as a fifth limiting portion and a sixth limiting portion. A gap between the fifth limiting portion and the sixth limiting portion may also form an installation site, which may also be used for installing components that is capable of contacting with the ribbon surface to flatten the ribbon.

When the housing 1 is simultaneously provided with the first limiting member 114, the second limiting member 115 and the third limiting member 116, these three sets of limiting members form a limiting structure that collectively limits the ribbon, ensuring its flatness and normal movement, thereby avoiding abnormal conditions such as local bulging or folding on the ribbon close to the mating area 15, and thus guaranteeing the printing effectiveness.

The limiting portions of the second limiting member 115 and the third limiting member 116 may be a column structure, a plate structure, or a block structure, or the like, as described above for the various types of structures of the first limiting member 114.

During the movement of the ribbon, there is also a hidden risk of wrinkles developing locally. If the wrinkles or similar conditions occur on a local portion of the ribbon, it may also affect the printing effectiveness.

Therefore, please refer to FIGS. 16 and 17, some embodiments of this disclosure provide a printing consumable. The housing 1 of the printing consumable is provided with a mating area 15 and a first opening 101. The first opening 101 is the same as that in the above embodiments. In this embodiment, a flattening member 117 is provided at the first opening 101. The flattening member 117 covers a portion of the first opening 101 and is located on the outer side of the ribbon in the second direction F1, so that it may at least partially contact with the ribbon surface under certain conditions. For example, the flattening member 117 may maintain in contact with the ribbon surface, or have a tiny gap from the surface of a normally non-bulging ribbon. Once the ribbon surface shows a tendency to wrinkle or bulge, the ribbon will contact with the flattening member 117, which then smooths the ribbon surface, thereby preventing the wrinkles and similar conditions.

The flattening member 117 and the first limiting member 114 are arranged along the ribbon supply path, but their order is not limited. The flattening member 117 may be in the upstream position, or the first limiting member 114 may be in the upstream position.

The flattening member 117 may be a fixed member or a rotatably arranged rolling member. For example, the flattening member 117 may be a structure like a column, a plate, or a block, or it may be a rotatably arranged roller.

For example, as shown in FIG. 16, the flattening member 117 includes a flattening plate. The flattening plate is arranged along the first direction F2. It may protrude from one side edge of the first opening 101 and extend towards the other side edge of the first opening 101. The flattening plate may be a single integral protrusion extending continuously from one side edge of the first opening 101 to the other side edge of the first opening 101in the first direction F2, or it may include two sub-plates arranged opposite to each other in the first direction F2. The two sub-plates may abut against each other or have a gap therebetween. When the flattening plate is a single integral protrusion, it may be formed on the first housing portion 11 or the second housing portion 12. When the flattening plate includes two sub-plates, one is formed on the first housing portion 11, and the other is formed on the second housing portion 12.

For example, as shown in FIG. 17, the flattening member 117 is or includes a rolling member. The rolling member is a component that rotates about its own axis, such as a roller. In this way, when the ribbon contacts with the rolling member during movement, the frictional resistance between the rolling member and the ribbon is reduced, and thus minimizing damage to the ribbon surface.

The axis of the rolling member is perpendicular to the second direction F1, and may be parallel to a width or length direction of the ribbon. For example, an axis of the rolling member is parallel to the first direction F2, that is, the width direction of the ribbon. This helps increase a contact area between the rolling member surface and the ribbon surface.

A cross-sectional contour of the rolling member may be a circular, an elliptical, or a polygonal such as a pentagonal, a hexagonal, or the like. For example, the rolling member is a roller with a circular or elliptical cross-sectional contour.

A diameter of the rolling member is L1. For example, L1 ≥ 1 mm. For example, the diameter L1 of the rolling member ≥ 1.8 mm. For instance, the diameter L1 of the rolling member 117a is 4 mm. This avoids the rolling member being too small, thereby ensuring an excellent flattening effect.

The rolling member may have a center hole through which a shaft passes. The shaft may include two sub-shafts respectively provided on the first housing portion 11 and the second housing portion 12. The sub-shafts may be directly connected to the first housing portion 11 or the second housing portion 12. Alternatively, the flattening member 117 also includes fixing portions located on two axial sides of the rolling member. The two fixing portions are integrally formed with the first housing portion 11 and the second housing portion 12, respectively. The sub-shafts are provided on the fixing portions.

During installation, the rolling member is first inserted onto one of the sub-shafts. Then, the first housing portion 11 and the second housing portion 12 are snapped together to make the other sub-shaft also be inserted into the center hole of the rolling member, thereby completing the installation and fixation of the rolling member and effectively ensures its rotatability.

For example, an antistatic layer is provided on the flattening member 117. The antistatic layer is at least located on a surface on a side of the flattening member 117 facing the ribbon, or all outer surfaces of the flattening member 117 are provided with the antistatic layer. In this way, the flattening member 117 has a function of removing dust from a surface on a side of the ribbon facing it. When the printing consumable is installed into the printer main body, the antistatic layer is electrically connected to a metal point on the printer main body. For example, the position of the flattening member 117 may be set such that the conductive layer may directly contact with the metal point on the printer main body, or it may be connected to the metal point on the printer main body via a wire. Therefore, during the use of the printing consumable, the flattening member 117 may conduct static electricity to the printer main body, thereby reducing the amount of dust adsorbed by the ribbon.

When the flattening member 117 is a rolling member or includes a rolling member, a surface of the rolling member that contacts with the ribbon may be plated with the antistatic layer.

When the flattening member 117 is a rolling member or includes a rolling member, a suppression member 118 may also be provided at the first opening 101. As shown in FIG. 17, a projection of the suppression member 118 in the first direction has at least a partial area located on a side of the rolling member facing the mating area 15, that is, it is on the downstream of the rolling member along the ribbon supply path. The suppression member 118 covers a partial area of the first opening 101 and is located on the outer side of the ribbon in the second direction F1, so that it is capable of pressing against the ribbon to prevent it from warping or floating outward.

Thus, the suppression member 118 may press against the ribbon to eliminate the slight upward warping of the ribbon segment downstream of the rolling member caused by the rolling member pressing against the ribbon.

The suppression member 118 may be a column, a plate, or a block. Two suppression members 118 may be provided, for example, two the suppression members 118 are symmetrically distributed in the first direction F2. For example, as shown in FIG. 17, the suppression member 118 is located on one or both axial sides of the rolling member.

The suppression member 118 is provided on the second housing portion 12 or the first housing portion 11, protruding from the second wall plate 121 or the first wall plate 111 along the first direction F2. In other words, the suppression member 118 belongs to a solid portion of the side plate 113, and is formed by a local portion of the solid portion of a non-opening region of the side plate 113.

When the flattening member 117 includes fixing portions at both axial ends of the rolling member, the suppression member 118 and the fixing portion have a gap in the second direction F1 or are integrally connected. For example, the suppression member 118 and the fixing portion have a gap therebetween in the second direction F1. A projection of the suppression member 118 in the second direction F1 has at least a partial area located on a side of the rolling member closer to the mating area 15.

For example, along the ribbon supply path, the first limiting member 114 is located on the downstream of the flattening member 117. The suppression member 118 is located between the flattening member 117 and the first limiting member 114, and is closer to the flattening member 117. By sequentially undergoing the flattening of the ribbon by the flattening member 117, the elimination of ribbon floating/warping by the suppression member 118, and the anti-bulging limitation of the ribbon by the first limiting member 114, the flatness of the ribbon may be effectively ensured.

The suppression member 118 is closer to the flattening member 117, thereby providing a better effect in eliminating warping of the ribbon.

For example, the projections of the suppression member 118 and the rolling member in the first direction F2 (that is, an axial direction of the rolling member) at least partially overlap.

Exemplarily, a height difference between top surfaces of the suppression member 118 and the rolling member in the second direction F1 (the height difference of their top surfaces in the second direction F1) is H, where H ≤ 0.3 mm. In this way, on one hand, it may prevent the rolling member from protruding outward and being damaged on the surface. If the surface of the rolling member is uneven, it may damage the ribbon. Therefore, it may enhance the protection of the rolling member and the ribbon. On the other hand, a dimensional requirement may also ensure an installation accuracy of the rolling member, and thus avoiding tilting.

Along the supply path of the ribbon, that is, in the third direction, a diameter of the rolling member is L1, a width dimension of the suppression member 118 is L2, and a distance between the suppression member 118 and the first limiting member 114 is L3, where L2 ≤ L1, and/or L2 ≤ L3. If the dimension of the suppression member 118 in the third direction is too large, it will excessively press down on the ribbon, which may easily affect the flattening effect of the flattening member 117 on the ribbon.

Please refer to FIG. 17, in some embodiments of the present disclosure, an identification member 119 is provided at the first opening 101 of the housing 1. At least a portion of the identification member 119 is a solid structure to cover a partial area of the first opening 101 so that it is identified. The identification member 119 is located on a side of a centerline of the housing 1 in the third direction, and the third direction is perpendicular to the width direction and thickness direction of the ribbon. The identification member 119 is provided to cooperate with an external identification machine to identify the printing consumable to obtain information. For example, it may be used for packaging identification during the processing. In the packaging stage, sometimes multiple printing consumables need to be stacked together for packaging. During this process, it is easy for the printing consumables to be placed in reverse (for example, the first wall plate 111 of other printing consumables faces upward and the second wall plate 121 faces downward, while some printing consumables are placed in reverse, causing the first wall plate 111 to face downward and the second wall plate 121 to face upward), resulting in uneven packaging. Generally, an identification machine is set up for identification. When the identification member 119 is provided on the printing consumable, since the identification member 119 is only located on one side of the centerline of the housing 1 in the third direction, that is, the identification member 119 is only provided on one side of the centerline of the printing consumable, the identification machine only needs to identify the identification member 119. If the identification member 119 is identified, it indicates that the printing consumable is placed correctly. If the identification member 119 is not identified, it indicates that the printing consumable is placed in reverse. In this way, identification efficiency and accuracy is improved. Certainly, the arrangement of the identification member 119 may also be used for identification of other functions, such as identification of an end of the ribbon, identification of whether a gap paper is used normally, or the like, which will not be elaborated herein.

The identification member 119 protrudes from the second wall plate 121 or the first wall plate 111 along the first direction F2 to cover a partial area of the first opening 101. One end of the identification member 119 is connected to the second wall plate 121 or the first wall plate 111, and the other end extends along the first direction F2. The other end of the identification member 119 may extend to the middle of the first opening 101 in the first direction F2, or it may extend all the way to connect with the first wall plate 111 or the second wall plate 121.

The identification member 119 may be provided as one, or multiple identification member 119 may be distributed on the printing consumable. It may be formed on the first housing portion 11 or on the second housing portion 12. When multiple identification member 119 are provided, some may be formed on the first housing portion 11 and some may be formed on the second housing portion 12.

At least a portion of the identification member 119 is a solid structure. It may be entirely a solid member, or partially provided with hollows. Exemplarily, the identification member 119 may be a block or plate, or the like.

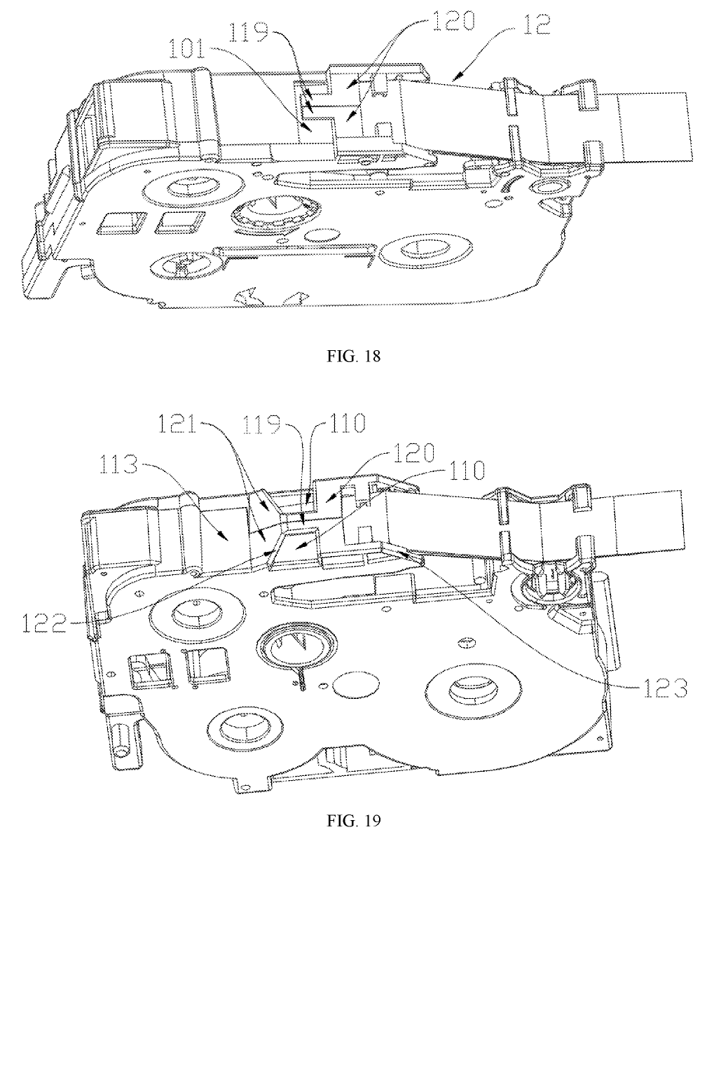

Please refer to FIG. 18, in some other embodiments of the present disclosure, a supporting column 120 is provided at the first opening 101. The supporting column 120 is arranged along the first direction F2, and its two ends in the first direction F2 are respectively connected to the first wall plate 111 and the second wall plate 121. For example, the supporting column 120 may protrude from a side edge of the first opening 101 in the first direction F2 and extend all the way to connect with the other side edge of the first opening 101. In this way, its two ends respectively support portions of the housing 1 on both sides of the first opening 101 in the first direction F2. Alternatively, the supporting column 120 includes two sub-columns arranged opposite to each other along the first direction F2. The sub-columns protrude from one side edge of the first opening 101 and extend toward the other side edge of the first opening 101, and the two sub-columns abut against each other. The arrangement of the supporting column 120 may support the first wall plate 111 and the second wall plate 121 at the first opening 101, enhancing the structural strength of the housing 1, and thus avoiding the problem of local strength reduction causing consequent susceptibility to deformation due to a large opening area.

Two ends of the supporting column 120 are respectively connected to the second wall plate 121 and the first wall plate 111. When the supporting column 120 is an integral component, it may be formed on the first housing portion 11, such as being integrally connected to the first wall plate 111, or be formed on the second housing portion 12, such as being integrally connected to the second wall plate 121. When the supporting column 120 includes two sub-columns, a first sub-column may be formed on the first housing portion 11, and a second sub-column may be formed on the second housing portion 12. When the first housing portion 11 and the second housing portion 12 are engaged and connected to each other, the first sub-column and the second sub-column abut against each other.

In the embodiments the supporting column 120 is provided, the identification member 119 may be further provided. In such embodiments, the identification member 119 protrudes from the supporting column 120, specifically protruding and extending from a side of the supporting column 120 in the third direction along the third direction. At least a portion of the identification member 119 is a solid structure to cover a partial area of the first opening 101, so that it may be identified. Exemplarily, the identification member 119 may be a block or plate, or the like.

Referring to FIG. 19, in the first direction F2, the identification member 119 may correspond to a middle area of the supporting column 120. One side or both sides of the identification member 119 in the first direction F2 have a gap from an edge of the first opening 101, and this gap forms a local opening 110.

The local opening 110 may form a window for observing the ribbon or a window for detecting the ribbon type during production. Alternatively, the local opening 110 may provide a grippable portion for gripping devices such as a robotic arm, thereby facilitating automatic gripping of the printing consumable during production, and thus simplifying production.

It may be said that the local opening 110 communicates with the first opening 101, or it may be said that the unobstructed area of the first opening 101 located on a side of the identification member 119 forms the local opening 110.

Exemplarily, a spaced space between the first housing portion 11 or the second housing portion 12 and the identification member 119 in the first direction F2 forms the local opening 110.

Exemplarily, the local opening 110 includes a partial area of the first opening 101 and a notch located on the first wall plate 111 or the second wall plate 121. An edge of the second wall plate 121 or the first wall plate 111 has a missing area formed by recessing along the second direction F1, and this missing area forms the notch. This notch communicates with the first opening 101 and belongs to a component of the local opening 110.

Exemplarily, the identification member 119 is located on a side of the supporting column 120 away from the mating area 15. An end of the identification member 119 away from the supporting column 120 may have a distance from the side plate 113 in the third direction, so that the side of the identification member 119 away from the supporting column 120 still has a partially unobstructed area of the first opening 101. Alternatively, the end of the identification member 119 away from the supporting column 120 is connected to the reinforcement plate 121a. The reinforcement plate 121a covers a partial area of the first opening 101 and extends to a starting edge of the first opening 101 along the ribbon supply path to connect to the side plate 113. In the third direction, along a direction gradually approaching the identification member 119, the reinforcement plate 121a gradually tilts toward the outside of the printing consumable. That is, the end of the identification member 119 away from the supporting column 120 is connected to the side plate 113 through the reinforcement plate 121a, in other words, the reinforcement plate 121a connects the side plate 113 and the identification member 119. Such arrangement is capable of enhancing the structural strength of the housing 1.

Exemplarily, a side of the reinforcement plate 121a facing the identification member 119 has a first oblique edge 122a. One end of the first oblique edge 122a is connected to the identification member 119, and the other end is connected to the first wall plate 111 or the second wall plate 121. In a direction away from the identification member 119, it gradually tilts away from the reinforcement plate 121a.

Exemplarily, there are two the first oblique edges 122 distributed on two sides of the identification member 119 in the first direction F2.

Exemplarily, areas where the first wall plate 111 and the second wall plate 121 are connected to the mating area 15 are both provided with second oblique edges 123a. The second oblique edges 123a are located on a side of the mating area 15 facing the upstream of the ribbon supply path. In the third direction, along a direction gradually approaching the mating area 15, the second oblique edges 123a gradually tilt from the outside the ribbon cassette to the interior of the ribbon cassette.

From the above, it may be seen that the housing 1 has a receiving surface 61. The ribbon segment after passing through the mating area 15 will pass over the receiving surface 61 in a state covering it. Generally, a second opening 104 is opened on the housing 1 to expose a partial section of the ribbon. The second opening 104 is located on a downstream side of the mating area 15 along the ribbon supply path. The receiving surface 61 is exposed in the second opening 104 to abut against an external wheel member used for driving the ribbon to move. That is, the receiving surface 61 is used for abutting against the transport wheel 23 on the printer main body to clamp the ribbon, thereby cooperating with the rotation of the transport wheel 23 to achieve the purpose of making the ribbon move smoothly through a friction.

Combined with the arrangement of the first opening 101 and the limiting members in the above embodiments, it may be that the first opening 101 and the second opening 104 are distributed on the upstream and downstream sides of the mating area 15, and the first opening 101, the mating area 15, and the second opening 104 may communicate with each other. The first limiting member 114 is located at the first opening 101, and the second limiting member 115 and the third limiting member 116 are provided at the second opening 104, thereby collectively limiting the ribbon exposed from the housing 1. The receiving surface 61 is located between the second limiting member 115 and the third limiting member 116.

Exemplarily, referring to FIGS. 12, 13, and 17, a hollow hole communicating with the second opening 104 may be provided on the housing 1. A rotatable cylinder is installed in the hollow hole, and a cylindrical surface of the rotatable cylinder forms the receiving surface 61. The rotatable cylinder is used for cooperating with the transport wheel 23 on the printer main body.

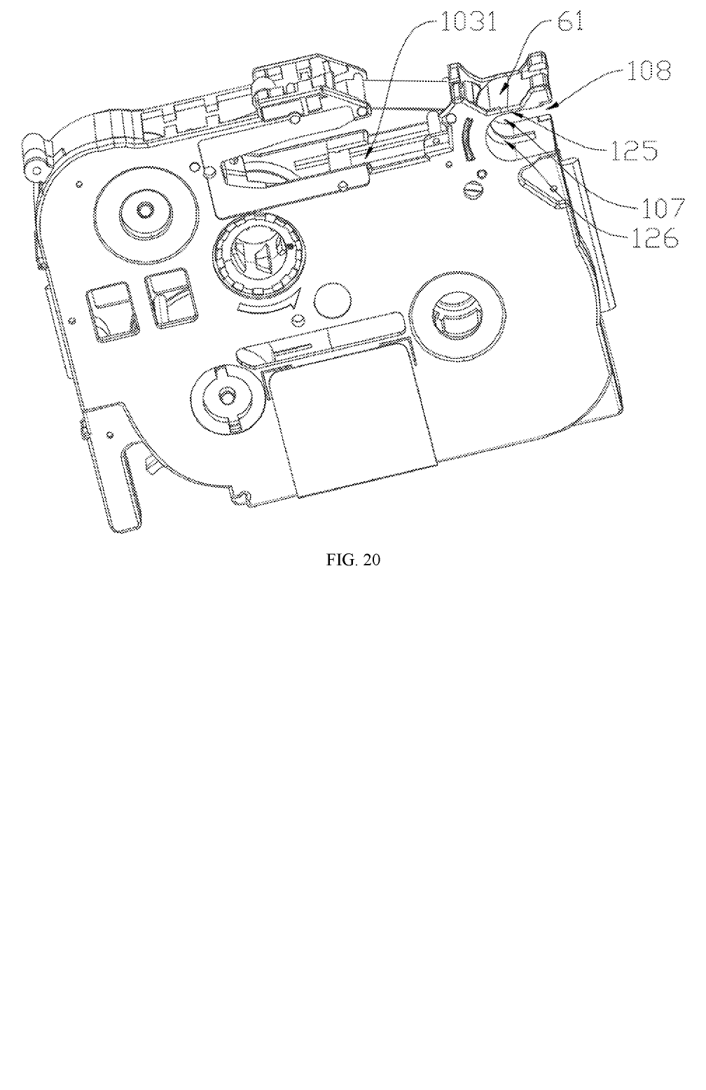

Please refer to FIGS. 20-22. The present disclosure also provides some embodiments. In such embodiments, a receiving plate 125 is provided on the housing 1 of the printing consumable. The receiving plate 125 is formed on the first housing portion 11 or the second housing portion 12, and is integrally formed with the first wall plate 111 or the second wall plate 121. Meanwhile, a partial plate section of the receiving plate 125 is located at the second opening 104 to be exposed on the surface of the housing 1. A plate surface of this plate section facing the outside of the ribbon cassette forms the receiving surface 61. In this way, compared to installing the rotatable cylinder on the housing 1, by forming the receiving surface 61 through the receiving plate 125 integrally formed on the housing 1, the structure is simpler and is more convenient for processing and manufacturing.

The housing 1 also has a guide hole 107. The guide hole 107 is used for cooperating with components on the printer main body, such as allowing positioning components on the printer main body to be inserted. Exemplarily, the guide hole 107 is enclosed by the receiving plate 125. For example, the receiving plate 125 is U-shaped and encloses to form the guide hole 107 having a side opening 108. An axial direction of the guide hole 107 is arranged along the first direction F2, and the side opening 108 is located on a radial side of the guide hole 107 and connects to the outside of the housing 1. It may also be said that a portion of a hole wall of the guide hole 107 is missing, thereby forming the side opening 108 that radially communicates with the outside of the housing 1.

The guide hole 107 has a side opening 108 on the radial side, which will be more convenient for positioning with the printer main body, and thus improving the positioning adaptability of different types of printing consumable structures and the printer main body.

The side opening 108 is located between the second wall plate 121 and the first wall plate 111, and is formed on a surface of the housing 1. It may be understood that the U-shaped opening of the U-shaped receiving plate 125 faces toward the side plate 113, and the side plate 113 does not cover the U-shaped opening of the receiving plate 125, thus forming the side opening 108 of the guide hole 107 that communicates with the outside of the housing 1. A radial cross-section of the guide hole 107 may be a circle, an ellipse or a waist shape with an opening, or it may be a polygon.

Exemplarily, a reinforcement structure is provided in the guide hole 107. The reinforcement structure includes a reinforcement rib 126 protruding from the hole wall of the guide hole 107 and/or a supporting rod 127 with two ends connected to the hole wall of the guide hole 107. By providing reinforcement structures such as the reinforcement rib 126 and/or the supporting rod 127, a structural strength of the receiving plate 125 is enhanced, thereby increasing a pressure that the receiving surface 61 is capable of withstanding when cooperating with the transport wheel 23.

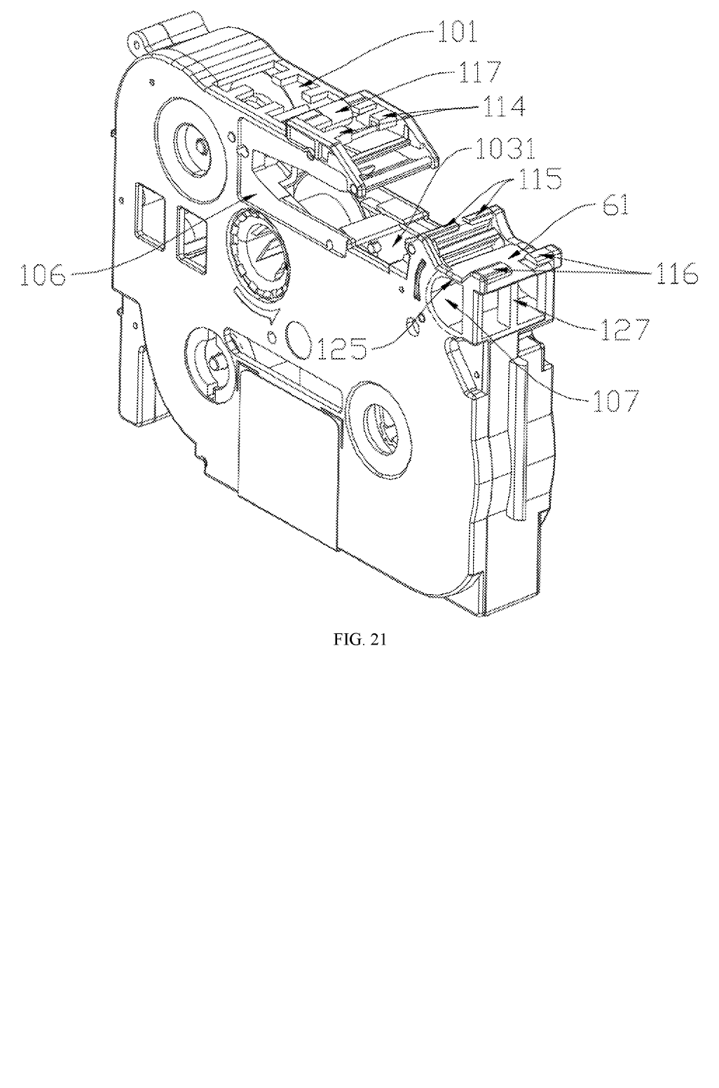

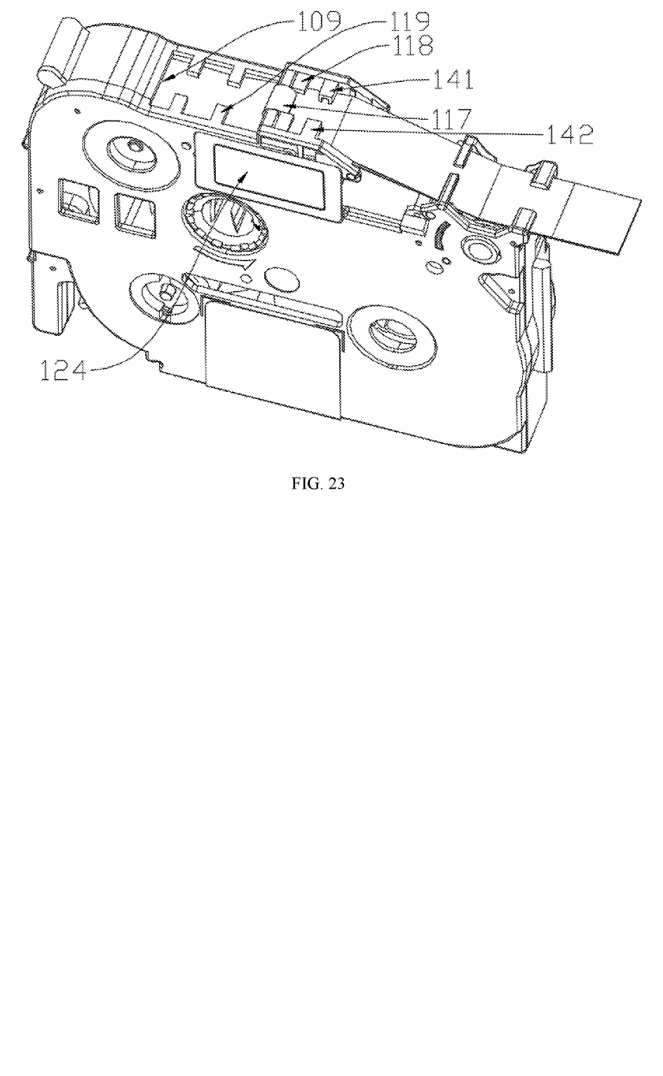

Exemplarily, as shown in FIGS. 21 and 23, the reinforcement structure includes a supporting rod 127 provided at the side opening 108. The supporting rod 127 extends from one side edge of the side opening 108 to the other side edge in the second direction F1 to support the receiving plate 125.

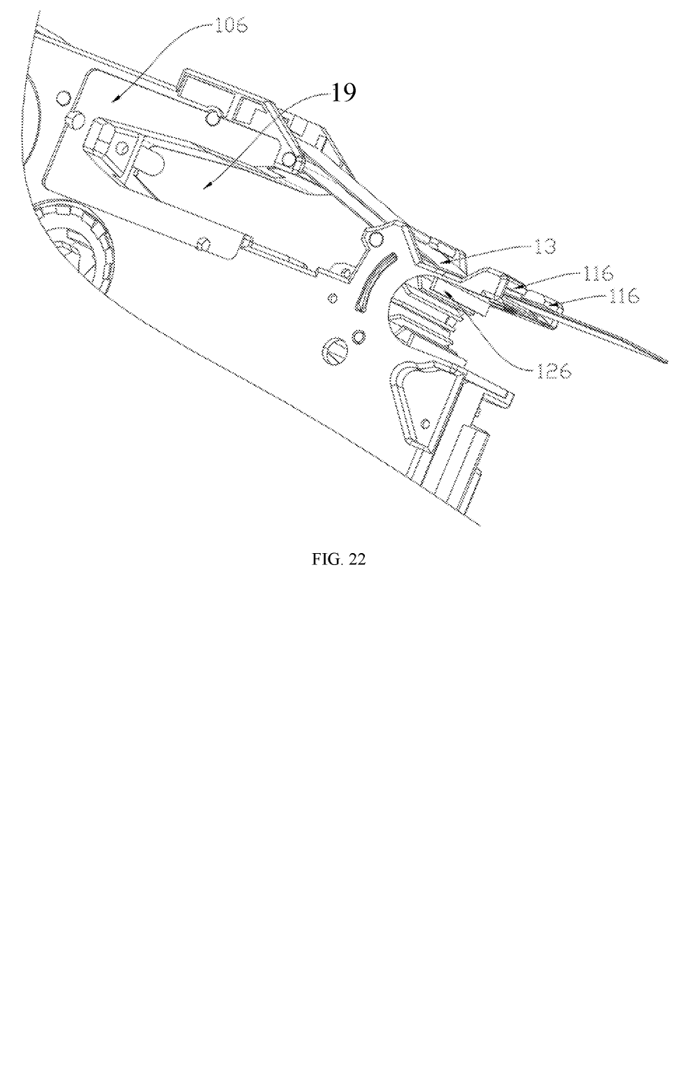

The reinforcement structure includes a reinforcement rib 126 protruding from the hole wall of the guide hole 107. The reinforcement rib 126 extends along the axial direction of the guide hole 107 and is distributed along a circumferential direction of the guide hole 107, as shown in FIG. 22, or the reinforcement rib 126 extends along the circumferential direction of the guide hole 107, as shown in FIG. 9.

Please refer to FIGS. 12, 14, and 15. In some embodiments, a first protrusion and a second protrusion arranged along the second direction F1 protrude from the side plate 113 of the housing 1. The first protrusion 131 and the second protrusion 132 are respectively provided on the first housing portion 11 and the second housing portion 12. For example, the first protrusion 131 is formed on the first housing portion 11, and the second protrusion 132 is formed on the second housing portion 12. One of the first protrusion and the second protrusion is provided with an insertion column 133, and the other is provided with an insertion slot for the insertion column 133 to be inserted into. When the first housing portion 11 and the second housing portion 12 are snapped together, the first protrusion 131 and the second protrusion 132 are also connected through the insertion structure, thereby enhancing the engagement strength of the first housing portion 11 and the second housing portion 12.

Referring to FIGS. 12 and 23, a mounting hole 19 with a through structure along the first direction F2 is provided on the housing 1. The mounting hole 19 communicates with the mating area 15. In some embodiments, please refer to FIGS. 16, 23, and 24, a cover sheet 124 is provided on the first wall plate 111 or the second wall plate 121 to cover a portion of the mounting hole 19. The cover sheet 124 is detachably or openably/closably arranged. The cover sheet 124 is provided on an axial side of the mounting hole 19 and may be exposed on the surface of the housing 1. The arrangement of the cover sheet 124 prevents dust and other impurities from entering the interior of the housing 1 through the mounting hole 19 and contaminating the ribbon. When the printing consumable needs to be installed on the printer main body, or when the printing consumable is sold from the factory, to avoid interference between the cover sheet 124 and the printer main body affecting the use of the printing consumable, the cover sheet 124 may be removed, or the openably/closably provided cover sheet 124 may be flipped open (or pushed open by the printing head of the machine).

The cover sheet 124 may be connected to the housing 1 by a screw or a magnetic attraction structure, or one end of the cover sheet 124 may be rotatably connected to the housing 1 through a pivot shaft to form an openable/closable connection. Alternatively, the cover sheet 124 may have a snap-fit structure and/or an insertion structure. For example, the housing 1 has an insertion hole, and the side of the cover sheet 124 facing the interior of the housing 1 is provided with an insertion column. The insertion column is used for being inserted into the insertion hole, and it may be interference-fitted with the insertion hole to fasten the cover sheet 124. The housing 1 may also have a hook groove, and the side of the cover sheet 124 facing the interior of the housing 1 is provided with a hook-shaped buckle. The hook-shaped buckle is used for being snapped into the hook groove to form a snap-fit connection to fix the cover sheet 124. When both the insertion structure and the snap-fit structure are provided, a protruding column may be provided on the cover sheet 124. An end of the protruding column is provided with or forms the insertion column, and a wedge-shaped body may protrude from a side wall of the protruding column. The wedge-shaped body and a column body of the protruding column form the buckle that is snapped into the hook groove.

The side of the cover sheet 124 facing the interior of the housing 1 may also be provided with a crossbeam. The crossbeam may be used for cooperating with the printing head, and it may also match with a size of the mounting hole 19 to be interference-fitted with the mounting hole 19, so as to be inserted into the mounting hole 19 to hold or position the cover sheet 124. The crossbeam may be block-shaped or plate-shaped.

The cover sheet 124 may protrude from the surface of the housing 1 or be embedded in the housing 1. For example, a groove 106 for embedding the cover sheet 124 is provided on the first wall plate 111 or the second wall plate 121. The groove 106 extends around a partial hole area of the mounting hole 19 along a circumferential direction of the mounting hole 19. The cover sheet 124 is embedded in the groove 106. It may be snapped into the groove 106 through dimensional fit, or it may be connected to the housing 1 by screws.

Exemplarily, the cover sheet 124 may only cover the first wall plate 111 or the second wall plate 121, presenting a flat plate structure.

Exemplarily, the cover sheet 124 may have a bent structure, including a first portion covering the second wall plate 121 or the first wall plate 111 and a second portion covering at least a partial area of the first opening 101. The first portion and the second portion are connected at an angle, and the entire cover sheet 124 may be L-shaped. In this way, the cover sheet 124 may not only cover the mounting hole 19 but also cover the first opening 101, thereby preventing dust and other impurities from entering the interior wall of the housing 1 through the first opening 101.

Please refer to FIG. 17, in some embodiments, a mounting hole 19 with a through structure along the first direction F2 is provided on the housing 1. The mounting hole 19 communicates with the mating area 15. A groove 106 recessed along the first direction F2 is provided on the first wall plate 111 or the second wall plate 121. The groove 106 extends around a partial hole area of the mounting hole 19 along a circumferential direction of the mounting hole 19. The arrangement of this groove 106 may be used for embedded installation of a certain component and to avoid that the component protruding from a surface of the first wall plate 111 or the second wall plate 121. In such embodiments, the housing 1 of the printing consumable is provided with the groove 106, but is not connected with a component such as the cover sheet 124. This structure facilitates a manufacturer or a user to decide whether to install components such as the cover sheet 124 according to requirements.

In some embodiments, a third opening 1031 is provided on the housing 1. The third opening 1031 is provided on the hole wall of the mounting hole 19, in other words, at least a portion of the hole wall of the mounting hole 19 is missing to form the third opening 1031, as shown in FIGS. 20 and 21. The third opening 1031 may be formed on the cantilever portion 14 or provided on a portion of the hole wall opposite to the cantilever portion 14. The arrangement of the third opening 1031 enables the printing consumable be lightweight, and also facilitates intuitively observing a ribbon amount, a ribbon color, or the like inside the housing 1 through the third opening 1031.

It may be understood that in the various embodiments of the present disclosure, the order of the processes does not imply a sequence of execution. The execution order of each process should be determined by its function and internal logic, and should not constitute any limitation on the implementation process of the embodiments of the present disclosure.

It may be understood that the various implementations described in the present disclosure may be implemented either individually or in combination, and the embodiments of the present disclosure do not impose any limitations in this regard.

Those skilled in the art may clearly understand that, for the convenience and brevity of description, the specific working processes of the systems, devices, and units described above may be referred to the corresponding processes in the aforementioned method implementations, and will not be repeated herein.

The above are only specific embodiments of the present disclosure, but the protection scope of the present disclosure is not limited thereto. Any change or substitution that is readily conceived by a person skilled in the art within the technical scope disclosed in the present disclosure shall be covered within the protection scope of the present disclosure. Therefore, the protection scope of the present disclosure should be based on the protection scope of the claims.

What is claimed is:

1. A printing consumable for a printer, the printer comprising a printer main body having a first ribbon driving wheel, the printing consumable comprising:
a housing, the housing having a first outlet;
a first spool core, the first spool core being rotatably disposed in the housing; and
a receiving portion, the receiving portion being disposed in the housing, the receiving portion having a receiving surface exposed from the housing, and the receiving surface being configured to cooperate with the first ribbon driving wheel to provide a clamping force.

2. The printing consumable for the printer according to claim 1, wherein the housing further has a second outlet, and the second outlet is spaced apart from the first outlet; and
the printing consumable comprises a second spool core, and the second spool core is rotatably disposed in the housing.

3. The printing consumable for the printer according to claim 2, wherein a peripheral side wall of the housing has an opening, the opening has a first wall surface and a second wall surface facing each other, the receiving portion is located at the opening and is disposed closer to the first wall surface relative to the second wall surface, the receiving surface is exposed via the opening, and the second outlet is defined between the receiving portion and the second wall surface.

4. The printing consumable for the printer according to claim 3, wherein a surface of the receiving portion close to the second wall surface is a guide convex curved surface, and the guide convex curved surface is connected to the receiving surface.

5. The printing consumable for the printer according to claim 1, wherein an outer peripheral surface of the receiving portion is provided with a first positioning structure, an inner surface of the housing is provided with a second positioning structure, the first positioning structure is one of a protrusion and a groove, the second positioning structure is the other of the protrusion and the groove, and the protrusion fits within the groove.

6. The printing consumable for the printer according to claim 1, wherein a wall plate on a side of the housing along a first direction is a first wall plate, the first wall plate has a first clearance hole, the receiving portion has a second clearance hole penetrating through the receiving portion along the first direction, the second clearance hole and the first clearance hole are directly opposite each other in the first direction, and the second clearance hole and the first clearance hole are configured to avoid a ribbon driving shaft of the printer main body.

7. The printing consumable for the printer according to claim 6, wherein the receiving portion comprises a first sleeve, a second sleeve and a connecting rib, an outer peripheral surface of the first sleeve has the receiving surface, the second sleeve is located in the first sleeve and is spaced apart from the first sleeve, the second sleeve forms at least a portion of the second clearance hole, and the connecting rib is connected between the first sleeve and the second sleeve.

8. The printing consumable for the printer according to claim 7, wherein a wall plate on the other side of the housing along the first direction is a second wall plate, the first sleeve is clamped between the first wall plate and the second wall plate, an end face of the first sleeve facing the first wall plate is provided with a limiting plate, and the limiting plate is located in the first clearance hole and cooperates with a hole wall of the first clearance hole for limiting.

9. The printing consumable for the printer according to claim 8, wherein, the second wall plate has a limiting hole, and an end of the second sleeve away from the first clearance hole is limited within the limiting hole.

10. The printing consumable for the printer according to claim 1, wherein an inner surface of the housing is provided with a protruding portion, the protruding portion is located on a side of the receiving portion facing away from the receiving surface and cooperates with the receiving portion to limit deformation of the receiving portion toward a side where the protruding portion is located.

11. The printing consumable for the printer according to claim 1, further comprising a ribbon accommodated in the housing; the housing comprising a first wall plate, a second wall plate and a side plate connecting the first wall plate and the second wall plate;
the side plate being provided with a mating area and a first opening that are capable of exposing a first partial section of the ribbon, a spool being rotatably disposed in the housing for winding the ribbon, to make the ribbon be driven to move to the mating area; and
along a supply path of the ribbon, the first opening being located on an upstream side of the mating area, the first opening being provided with a first limiting member, the first limiting member covering a first portion of the first opening and being located on an outer side of the ribbon in a second direction, and the second direction being perpendicular to a ribbon surface of the ribbon.

12. The printing consumable for the printer according to claim 11, wherein the first limiting member comprises a first limiting portion and a second limiting portion, and projections of the first limiting portion and the second limiting portion in the second direction are at least partially located at different positions in the first direction; and the first direction is parallel to a width direction of the ribbon.

13. The printing consumable for the printer according to claim 11, wherein the first limiting member comprises a first limiting portion and a second limiting portion that are opposite to and spaced apart from each other in the first direction, and the first direction is parallel to a width direction of the ribbon.

14. The printing consumable for the printer according to claim 11, wherein the housing comprises a main body portion and a cantilever portion protruding from the main body portion, the cantilever portion is configured to guide the ribbon to move toward the mating area, and the first opening is provided on the cantilever portion.

15. The printing consumable for the printer according to claim 11, wherein the housing is further provided with a second opening exposing a second partial section of the ribbon, the second opening is provided with a second limiting member covering a portion of the second opening, and along the supply path of the ribbon, the second opening is located on a downstream side of the mating area.

16. The printing consumable for the printer according to claim 11, wherein the first opening is provided with an identification member, at least a portion of the identification member is a solid structure to cover a second portion of the first opening so as to be identifiable, the identification member is located on a side of a centerline of the housing in a third direction, and the third direction is perpendicular to a width direction and a thickness direction of the ribbon.

17. The printing consumable for the printer according to claim 11, wherein the first opening is provided with a supporting column, the supporting column is arranged along the first direction, and two ends of the supporting column are respectively connected to the first wall plate and the second wall plate; and the first direction is parallel to a width direction of the ribbon.

18. The printing consumable for the printer according to claim 17, wherein an identification member protrudes from a side of the supporting column in a third direction, at least a portion of the identification member is a solid structure to cover a second portion of the first opening so as to be identifiable, and the third direction is perpendicular to the width direction and a thickness direction of the ribbon.

19. The printing consumable for the printer according to claim 1, further comprising the ribbon accommodated in the housing; the housing comprising a first wall plate, a second wall plate and a side plate connecting the first wall plate and the second wall plate;
the side plate being provided with a mating area and a first opening that are capable of exposing a partial section of the ribbon, a spool being rotatably disposed in the housing for winding the ribbon, to make the ribbon to be driven to move to the mating area; and
along a supply path of the ribbon, the first opening being located on an upstream side of the mating area, the first opening being provided with a flattening member, and the flattening member covering a portion of the first opening and being located on an outer side of the ribbon in a second direction, to contact with a surface of the ribbon at least in a situation that the surface of the ribbon shows a tendency to wrinkle or bulge.

20. A printer, comprising:
the printer main body; and
the printing consumable according to claim 1, the printing consumable being detachably mounted on the printer main body, the first ribbon driving wheel being configured to convey a finished ribbon outward, wherein a friction coefficient of the receiving surface is less than a friction coefficient of an outer peripheral surface of the first ribbon driving wheel.
